(19) United States
(12) Patent Application Publication
(10) Pub. No.: US 2015/0080076 A1
(43) Pub. Date: Mar. 19, 2015

(54) Methods and Apparatus for Wagering Games with Exposed Dealer Hand at Play Wager Interval

(71) Applicant: Bally Gaming, Inc., Las Vegas, NV (US)

(72) Inventors: Roger M. Snow, Las Vegas, NV (US); Ofir Ventura, Las Vegas, NV (US)

(21) Appl. No.: 14/030,253

(22) Filed: Sep. 18, 2013

(51) Int. Cl. G07F 17/32; A63F 1/00

(52) U.S. Cl. CPC G07F 17/3293; A63F 1/00; G07F 17/3244; A63F 2001/005
USPC 463/11; 273/292

(57) ABSTRACT

Methods of administering wagering games comprise accepting from a player an ante wager, dealing at least one card for a player hand, and dealing a number of cards for a dealer hand. A complete dealer hand is exposed to the player, either during or after dealing the cards for the dealer hand. Then, a game play election event is administered during which the administrator provides an opportunity to the player to place a play wager or fold. Then, at least one community card for the player hand is dealt, and all accepted wagers are resolved. Methods of administering wagering games, according to the present disclosure, may be implemented as live card games, single-player EGM (electronic gaming machine) games, multi-player EGM games, online games, and live card games with electronic betting interfaces.

### TECHNICAL FIELD

The present disclosure relates generally to methods of administering wagering games for casinos and other gaming establishments and to related systems and apparatus. More specifically, disclosed embodiments relate to methods of, and systems and apparatus for, administering wagering games including exposing a dealer hand prior to administering a game play election event, and prior to completing dealing of a player hand.

### BACKGROUND

Wagering games based on the outcome of randomly generated or randomly selected symbols are well known. Such games are widely played in gaming establishments such as casinos. The wagering games include card games, wherein the symbols comprise familiar, common playing cards. Card games such as twenty-one (also known as “blackjack”), poker, variations of poker, and the like are excellent card games for use in casinos. Desirable attributes of casino card games are that the games are exciting, they can be learned and understood easily by players, and they move or are played rapidly to a wager-resolving outcome.

Game administrators, such as casinos or other gaming establishments, frequently seek new games to offer to their clientele. Such games are often administered with one or more players playing against a dealer (who may also act as the banker) provided by the game administrator. Alternatively, the games may be administered with players playing against each other. In “card room” games, each player may have the option to act as a banker, while the gaming establishment administers the game and takes fees from the players.

Players typically enjoy games that can be played rapidly and that offer players a plurality of choices. A plurality of choices may heighten player interest in games.

U.S. Pat. No. 5,685,774 (Webb), issued Nov. 11, 1997, discloses poker-type card game that provides at least one player with options of wagering against a predetermined payout schedule, a dealer's hand, or both. In some embodiments, the player may be provided with a wild card that is retained and used repeatedly in each hand. The game may be carried out as a three-card game. When initial wagers are in place, the dealer deals a three-card hand to each player and to himself. After a play wager is made, the dealer reveals his cards, and the wagers are resolved. Players and the dealer receive three cards each. The player makes an ante wager to play against a dealer hand. After viewing his cards, the player elects to fold or make a play wager that is equal to 1× the ante wager. After the election has been received by the dealer, the dealer reveals his three-card hand and the hands are resolved. This game is marketed under the name THREE CARD POKER® by SHFL entertainment, Inc. of Las Vegas, Nev.

U.S. Pat. No. 7,628,689 (Snow), issued Dec. 8, 2009, discloses a system and method for conducting wagering games that may include the steps of receiving an ante wager and a blind wager from a player, dealing cards to form a player's hand, dealing cards to form a dealer's hand, after the player views his cards, the dealer receiving a play wager or an election from the player to fold, and resolving the ante and play wagers. The ante and play wagers win if the player's hand outranks the dealer's hand. The blind wager is resolved by comparing the player's hand with a predetermined winning criteria and with the dealer's hand. The player hand must beat the dealer hand and be a predetermined winning hand to win the blind wager. The blind wager pushes if the player's hand outranks the dealer's hand but does not satisfy the predetermined winning criteria. The blind wager loses when the dealer's hand outranks the player's hand. This game is marketed under the name ULTIMATE THREE CARD POKER® by SHFL entertainment, Inc., Las Vegas, Nev. Players may make a play wager that is 3× the ante wager when the player hand is a pair or better. Players make equal ante and blind wagers and may make side wagers as well. Both the player and the dealer receive three cards, and one card of the dealer's hand is dealt face up. The player then has an option to make a play wager or to fold. The play wager must equal (1×) the ante wager unless the player has a pair or better, in which case the play wager may be three times (3×) the ante wager. The dealer then reveals his three cards, and the wagers are resolved.

Accordingly, conventional wagering games, including conventional poker-based games such as three-card poker games, often involve dealing a complete player hand before a player is provided an opportunity to place a play wager. They also often involve waiting until after a player has been provided an opportunity to place a play wager before revealing a complete dealer hand. Thus, play wager determinations are often based on knowledge of a player hand's rank, with no knowledge or incomplete knowledge of the dealer's hand. Moreover, the ante and play wagers pay even money when the wagers are won.

### BRIEF SUMMARY

Methods of administering wagering games, according to embodiments of the present disclosure, include administering a game play election event either prior to or concurrently with, exposing an entire dealer hand to the player and while the player hand is incomplete. After the game play election event, the player hand may be completed by one or more community cards available to all players, or individual player cards. If community cards are used in some examples of the methods of the present disclosure, they are not utilized for the dealer hand. Accordingly, providing a player with an opportunity to place a play wager enables a player to elect to place a play wager or fold with full knowledge of the dealer's hand and with partial knowledge of the player's hand.

Thus, a method of administering a wagering game, according to at least one embodiment of the present disclosure, comprises accepting from a player an ante wager. At least one card defining a partial player hand is dealt, and a complete dealer hand is dealt. The complete dealer hand is exposed to the player. After exposing the dealer hand to the player, a game play election event is administered. During the event, a set of player game play options is provided to the player. The set of options comprises a fold election and a play wager election. A selected election is accepted, and at least one community card is dealt for the player hand. All accepted wagers are then resolved.

A method of administering a wagering game is disclosed comprising: providing a playing device layout bearing at least three distinct wager areas comprising an ante wager area, a blind wager area, and a play wager area, the at least three distinct wager areas defined by separate insignia displayed on the playing device layout. The method includes accepting from a player an ante wager at least partially covering the ante wager area, the ante wager designated to be resolved based on a rank comparison of a player hand rank and a dealer hand rank and another rank comparison of the dealer hand rank and a predetermined minimum qualifying rank. The method includes accepting from the player a blind wager at least partially covering the blind wager area, the blind wager equaling the ante wager, the blind wager designated to be resolved based on the rank comparison of the player hand rank and the dealer hand rank. A winning blind condition is a prerequisite for paying a blind payout defined by a paytable and based on the player hand rank and the player hand outranking the dealer hand. The method includes dealing two cards for a player hand, dealing three cards for a dealer hand, the dealer hand consisting of the three cards, and exposing the dealer hand to the player. After exposing the dealer hand to the player and without yet completing the player hand, the method includes administering a game play election event comprising the steps of providing a set of player game play options consisting of a fold election and a play wager equaling two times the ante wager and designated to be resolved based on the rank comparison of the player hand rank and the dealer hand rank. A winning play condition is a prerequisite for paying a play payout defined by a paytable and based on a dealer hand rank. The method further includes accepting from the player a game play election and resolving all accepted wagers.

Examples of the present disclosure may include a gaming table for administering a wagering game comprising: a playing surface including at least one player interface; at least one dealer interface; and at least one processor programmed to: accept an ante wager instruction associated with an ante wager on the wagering game; display a partial player hand; display a complete dealer hand; and prior to completing a player hand, accept a game play election instruction selected from a fold election and a play wager instruction. The processor may cause the display of at least one community card to form the complete player hand and resolve all accepted wagers' instructions.

Systems of the present disclosure include a system for administering a wagering game over a computer network, comprising an online gaming server. The system may interact with a player interface and associated display for accessing the online gaming server, and it may further interact with a network enabling communication between the online gaming server and a player interface. The online gaming server may be programmed to administer a game to a player interacting with the game through the player interface according to the following steps: receiving a signal from the player interface indicating the receipt of an ante and a blind wager from a player; delivering a visual representation of a complete hand of dealer cards and displaying the dealer hand on a player display associated with the player interface; delivering a partial hand of player cards and displaying the player cards on the player display associated with the player interface; administering a game play election event comprising providing a set of player game play options comprising a fold election and a play wager election; receiving a signal in response to a player input made at the player interface indicating the election; delivering at least one additional card and displaying a visual representation of the additional card on the display, adding said card to the player hand; and resolving all accepted wagers.

Live, electronic, hybrid, or online-implementations of the methods described herein may be configured for administration as either “play-for-pay” embodiments or “play-for-fun” embodiments. In play-for-pay embodiments, wagers having real-world monetary value are received and payouts having real-world monetary value may be distributed. Play-for-pay embodiments may include “house-banked” embodiments, “player-banked” embodiments, and “player pooled” embodiments. In house-banked embodiments, payouts are paid by, and losses are retained by, the game administrator (e.g., a casino or other gaming establishment), and the dealer may be provided by the game administrator. In player-banked embodiments, players or a professional banker may bank the game. A gaming establishment may profit from the administration of the game by, for example, “raking” the wagers (i.e., retaining a portion of the wagers for the house) or charging a seat or room fee in exchange for making the venue available for a predetermined time. In player pooled embodiments that may be configured for online play (e.g., “player-pooled progressive” configurations, “dividend refund” configurations), wagers may be raked by the game administrator and then pooled into a pot from which payouts are paid, which pot is eventually distributed to at least one player; thus, the game administrator retains only the raked amounts. Aside from play-for-pay embodiments, play-for-fun embodiments (e.g., “free play-for-fun” configurations, “social play-for-fun” configurations) involve receiving wagers having no real-world monetary value and distributing payouts having no real-world monetary value.

The actions described in this disclosure as the acts of a player, including betting, card selection (if any), card evaluation, card discards (if any), play elections, or any other actions, may be carried out by a processor, and instructions and data may travel over a network where the indicated actions are received as input to a device. The input-receiving device is typically physically remote from the game server or game host and is connected over a long-distance network, but may, additionally or alternatively, be implemented over a wired or wireless LAN (local area network) in one building, or even in one room, for example. In one embodiment, game play generated at the server or host location may be displayed on the same device as the receiving device. In some embodiments, game play may be conveyed to remote players in devices separate from the devices receiving input from a player, such as public screens or publicly broadcast data about a game coupled with individual or private input devices. The reception of an input at a device may be accomplished through any technology adapted for such a purpose including, but not limited to, keypads, keyboards, touchpads, touch screens, buttons, electronic tablets, cellphones, mice, optical location devices, eye movement/location detectors, sound input devices, etc. When discussing a device, it is understood the device may comprise multiple components and be complex, including hardware components combined with firmware and/or software, and may itself be a subcomponent of a larger system.

Yet other embodiments may comprise apparatuses and systems for administering wagering games according to embodiments of the disclosure.

### BRIEF DESCRIPTION OF THE DRAWINGS

While the disclosure concludes with claims particularly pointing out and distinctly claiming embodiments within the scope of the disclosure, various features and advantages of embodiments encompassed by the disclosure may be more readily ascertained from the following description when read in conjunction with the accompanying drawings, in which:

FIG. 1 is a flowchart diagram of a method of administering a wagering game, according to an embodiment of the present disclosure;

FIG. 2 is a diagram of a playing surface for implementation of a method of administering a wagering game, according to an embodiment of the present disclosure;

FIG. 3 is an enlarged diagram of a player position of the playing surface of FIG. 2;

FIG. 4 is a flowchart diagram of a method of administering a wagering game, according to a player-pooled progressive embodiment of the present disclosure;

FIG. 5 is a flowchart diagram of a method of administering a wagering game, according to a dividend refund embodiment of the present disclosure;

FIG. 6 is a perspective view of an individual electronic gaming device configured for implementation of embodiments of wagering games in accordance with the present disclosure;

FIG. 7 is a top view of a table configured for implementation of embodiments of wagering games in accordance with the present disclosure;

FIG. 8 is a perspective view of another embodiment of a table configured for implementation of embodiments of wagering games in accordance with the present disclosure, wherein the implementation includes a virtual dealer;

FIG. 9 is a schematic block diagram of a gaming system for implementing embodiments of wagering games in accordance with the present disclosure; and

FIG. 10 is a block diagram of a computer for acting as a gaming system for implementing embodiments of wagering games in accordance with the present disclosure.

### DETAILED DESCRIPTION

Methods for administering wagering games, including administering a game play election event before or during which a complete dealer hand is exposed to the player and after which at least one card is dealt for a player hand, are diagramed or illustrated in the figures and described below. Also illustrated and described are apparatus and systems that may be utilized to administering the wagering games of embodiments of the present disclosure.

The illustrations presented herein are not meant to be actual views of any particular act in a method of administering a wagering game, apparatus for use in administering a wagering game, or component thereof, but are merely idealized representations employed to describe illustrative embodiments. Thus, the drawings are not necessarily to scale. Additionally, elements common between figures may retain the same or similar numerical designation. Elements with the same number, but including a different alphabet character as a suffix should be considered as multiple instantiations of substantially similar elements and may be referred to generically without an alphabet character suffix. For example, elements 10a, 10b, and 10c may be a device that is instantiated three times and generically referred to herein as element 10.

The terms “gaming,” “gambling,” or the like, refer to activities, games, sessions, rounds, hands, rolls, operations, and other events related to wagering games such as web-based games, casino games, card games, dice games, and other games the outcome of which is at least partially based on one or more random events (“chance” or “chances”), and on which wagers may be placed by a player. In addition, the words “wager,” “bet,” “bid,” or the like, refer to any type of wager, bet, or gaming venture that is placed on random events, whether of monetary or non-monetary value. Points, credits, and other items of value may be purchased, earned, or otherwise issued prior to beginning the wagering game. In some embodiments, purchased points, credits, or other items of value may have an exchange rate that is not one-to-one to the currency used by the user. For example, a wager may include money, points, credits, symbols, or other items that may have some value related to a wagering game. Wagers may be placed in wagering games that involve the risk of real-world monetary value for the potential of payouts with real-world monetary value (e.g., the “play-for-pay,” “player banked”, “player-pooled progressive,” and “dividend refund” configurations, which are described in more detail below) or in wagering games that involve no real-world monetary risks for the player (e.g., the “play-for-fun” and “social play-for-fun” configurations, which are described in more detail below).

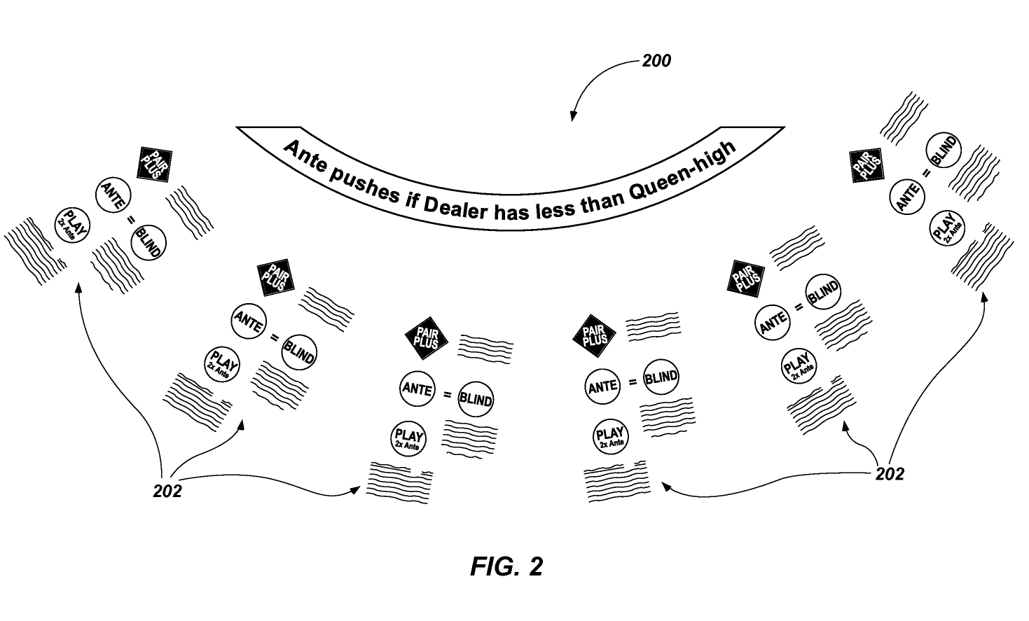

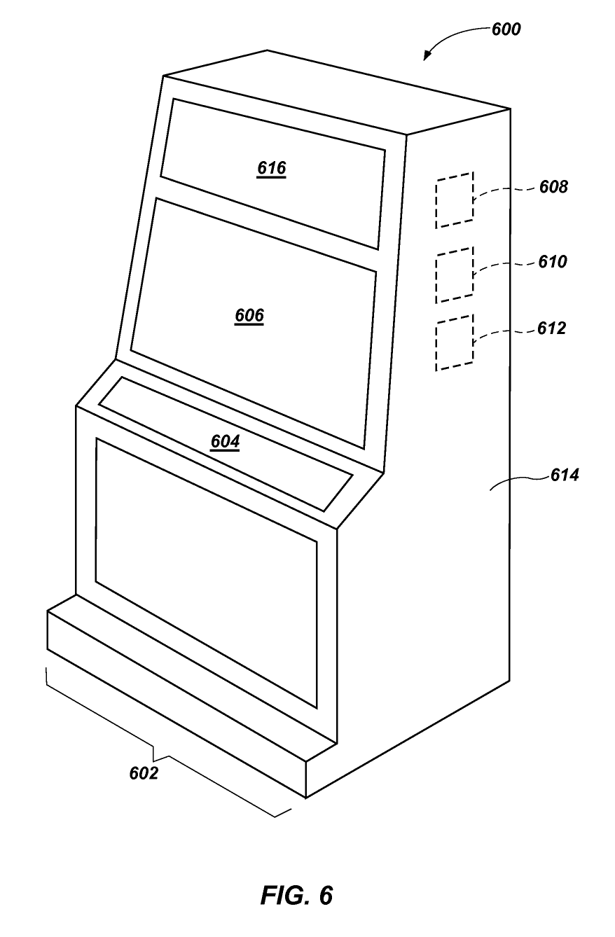

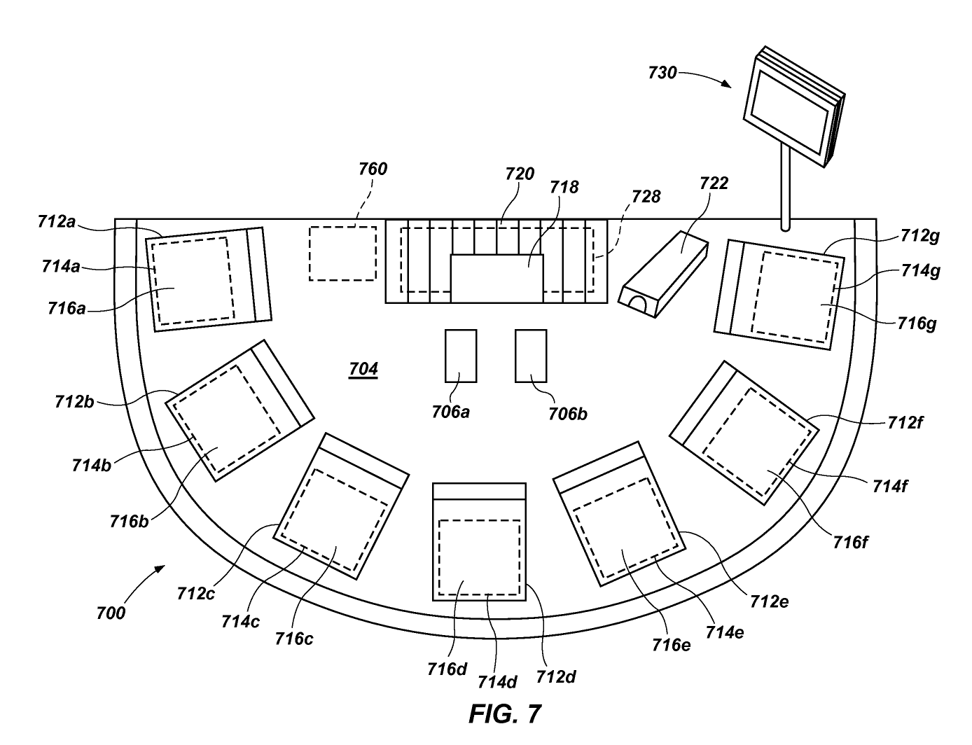

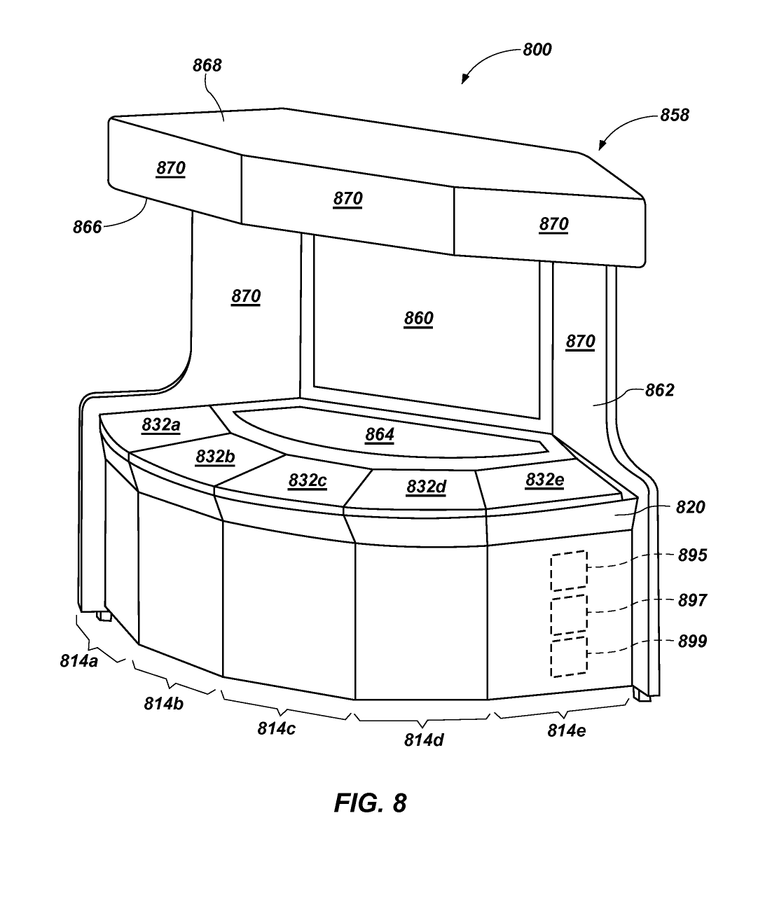

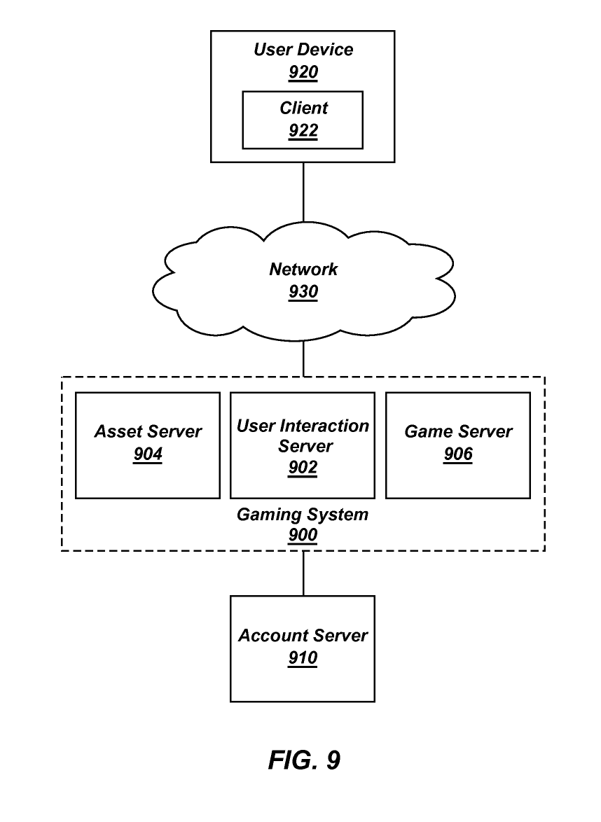

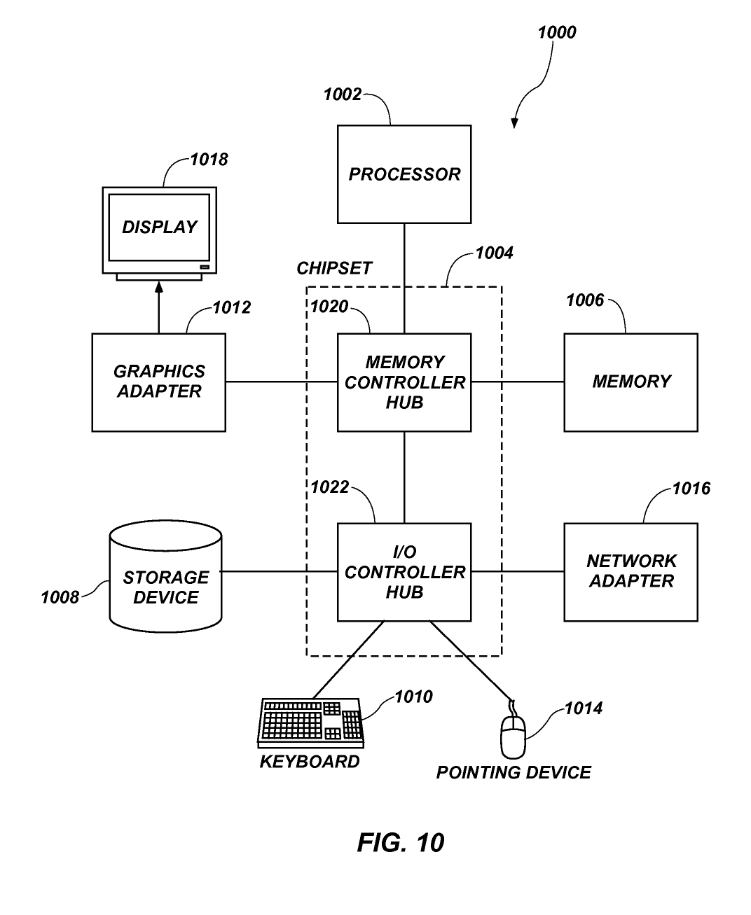

As used herein, the term “wager” includes any form of wagering value, including money, casino chips, other physical means for payment, and online or remote electronic authorization of a wager in any acceptable form to the casino or online or virtual game host. Also included are physical representations of money (e.g., casino chips) at a local gaming table (e.g., a gaming table with gaming table surface 200 (FIG. 2), table 700 (FIG. 7), table 800 (FIG. 8)), or electronic authorizations of a transfer of money or digital representations of money (e.g., digital representations of bills or coins, digital representations of chips, numerical quantities of money, numerical quantities of points, or numerical quantities of credits) at a local or remote electronic gaming device (e.g., individual electronic gaming device 600 (FIG. 6), table 700 (FIG. 7), table 800 (FIG. 8), user device 920 (FIG. 9), computer system 1000 (FIG. 10)). In the “play-for-fun” and “social play-for-fun” configurations, a “wager” may not have a cash value (i.e., a real-world monetary value).

For the purposes of this description, it will be understood that when an action related to accepting wagers, making payouts, dealing cards, selecting cards, or other actions associated with a player or a dealer are described, the description includes a player or a dealer taking the action, the results of the action on a live or virtual table or display, and, if applicable, the reception or detection of such an action in an electronic form where player and dealer choices, selections, or other actions are received at an electronic interface. This further includes the results of a virtual dealer and virtual players, where the actions described are actually generated by a computer (typically associated with an online game). By way of a further example, if dealing of a card is described herein, the description includes (but is not limited to) the following: the dealing of a card by a dealer from a deck, shuffler, a shoe, or other card source and the reception or placement of the card at a table location associated with a player or reception directly by a player; the generation and transmission of an electronic indication or representation of a card from a game play source or server to an electronic receiver, where the receiver may be at a table (using virtual cards) including players and/or virtual players and/or a dealer or virtual dealer, at a public display in a casino, at a remote location (e.g., using online or Internet game play), or at other locations. Also included is the representation of a card on a display or displays, and, if applicable to the action described, an electronic reception of an indication that the card has been received, selected, or otherwise interacted with at a location associated with a player or associated with a virtual player.

The term “visual representation of a card,” for purposes of an embodiment according to the present disclosure, includes a displayed representation of a card face, a card back, or a portion of a card face and may also include a rank and suit designation without the remaining graphics depicting a card face. For example, a processor may deliver an ace and heart symbol rather than deliver a two-dimensional image of an entire ace-of-hearts card face.

In addition, dealing of a card may refer to revealing a representation of a card on a scratch-off card (also referred to as a “scratcher”).

Disclosed embodiments relate generally to methods of administering wagering games that utilize cards, which methods include exposing a complete dealer hand before providing an opportunity to a player to place a play wager, during a game play election event, and before completing a player hand. The methods may also include completing a player hand, after administration of the game play event, with at least one community card available for all player hands. Bonus wagers may also be accepted. In alternate embodiments, additional player cards are provided to complete the hand instead of at least one community card. In yet other embodiments, a combination of player cards and community cards complete the player hand. In examples of the disclosed methods, community cards are not used to complete the dealer hand. In other examples, community cards are used by the players and the dealer to complete the player and dealer hands.

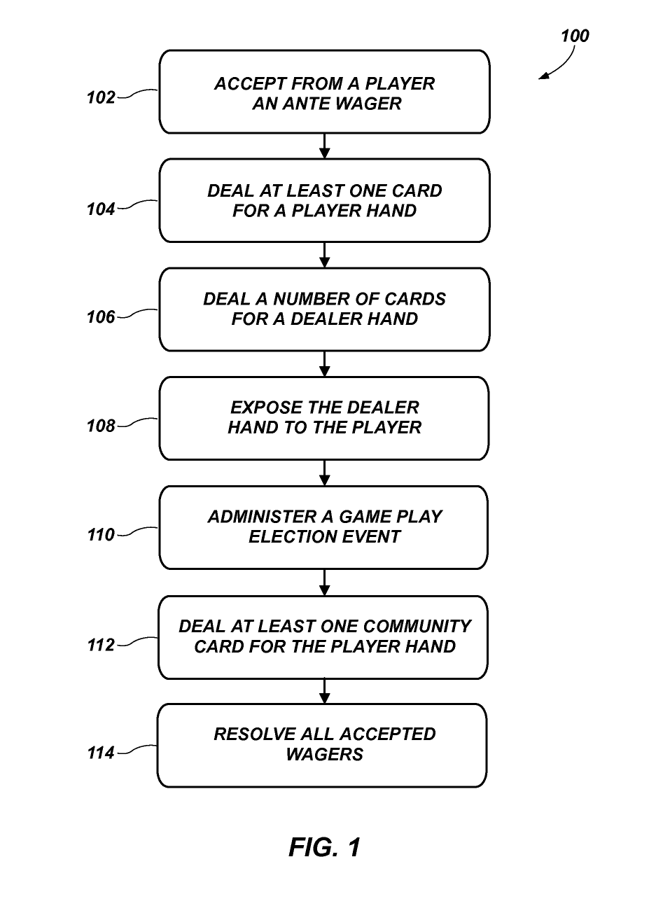

A flowchart diagram 100 of a method of administering a wagering game is illustrated in FIG. 1. The method includes accepting from a player an ante wager (operation 102), dealing at least one card for a player hand (operation 104), dealing a number of cards for a dealer hand (operation 106), exposing the complete dealer hand to the player (operation 108), administering a game play election event (operation 110), dealing at least one community card for the player hand (operation 112), and resolving all accepted wagers (operation 114).

Administering the wagering game includes administering at least one round of the wagering game. Administration may be conducted by a casino through its personnel or may be administered using a processor. With further reference to FIG. 1, administration of a round may begin, as indicated at operation 102, with accepting from a player an ante wager. The ante wager may be designated as a wager against the dealer (i.e., a wager designated to be resolved based on a rank comparison of a player hand rank and a dealer hand rank). In some embodiments, a payout on the ante wager, for meeting a winning condition, may be an even money payout (i.e., a payout equal to the ante wager). In other embodiments, the ante payout may be awarded based on a multiple of the ante wager, such as 2× the ante wager.

The ante wager, and any other wager simultaneously or subsequently accepted from the player, may be accepted by, for example, electronically accepting funds from a player account or other credit authorized via one or more communications media (e.g., via the Internet, wireless communications, a land line) on a remote electronic device (e.g., a personal computer, a laptop, a tablet computer, or a smartphone) by player input, electronically accepting funds from a player account authorized on a local wagering game administration device in a casino by player input, or accepting money or representations of money (e.g., chips) physically placed on a table in a designated betting area on a live gaming table surface in a casino. The gaming system that accepts wagers from online players may be the same system or a different system from the system that administers the actual game and game results. Suitable network architecture for administering casino style games and game results to an online casino gaming system is disclosed in U.S. Patent Application Publication No. 2013/0184059, published Jul. 18, 2013, to Costello et al., and U.S. Patent Application Publication No. 2013/0184079, also published Jul. 18, 2013, to Costello et al., the disclosures of which are incorporated herein in their entirety by this reference. The gaming systems described in the Costello publications deliver game results but do not administer client or casino funds.

One example of a suitable, local (i.e., traditional casino gaming equipment) wagering game administration device may comprise, for example, the chipless tables disclosed in U.S. Patent Application Publication No. 2010/0016050, published Jan. 21, 2010, to Snow et al., now U.S. Pat. No. 8,262,475, issued Sep. 11, 2012, the disclosure of which is incorporated herein in its entirety by this reference.

Regardless of the form and manner in which the ante wager is received, ante wagers may be received from multiple players wishing to participate in the round of the wagering game. The ante wager may be mandatory such that its acceptance is a prerequisite to completing the administration of the round with the player. The ante wager may be subjected to amount limitations, such as minimums and/or maximums, and may be received prior to revealing any cards potentially at play in the round of the game.

In examples described in the specification, the game is played with a standard 52-card deck of cards (ranks of two through ten, jack, queen, king, and ace of clubs, hearts, diamonds, and spades). In other forms, jokers or other wild cards may be present, special decks may be used (such as decks with certain cards removed), or multiple intermixed decks of cards may be used to administer the game. Special cards may be inserted into the deck, additional suits added, etc. It is understood that changing the deck composition changes the game math and may require that some of the rules be modified in order for the game to be commercially acceptable.

Though the descriptions herein may focus on administration of the wagering game with participation from “a player” or “the player,” it should be understood that each round may include administration, with the same acts (though outcomes and decisions may be different).

One or more other wagers in the round of the game may be received before, simultaneously with, or immediately after acceptance of the ante wager. For example, a blind wager may be received. The blind wager may be designated as a wager against the dealer and the wager amount may be limited to an amount equal to the ante wager. In some embodiments, a payout on the blind wager, for meeting at least one predetermined winning condition, may be defined by a paytable and be based on, e.g., the player hand rank. The blind bet may also be won when the player hand outranks the dealer hand and the player hand is a predetermined winning rank. Acceptance of the blind wager may be mandatory, i.e., a prerequisite to complete administration of the round of the game with the player. In other embodiments, the blind wager may be optional. The blind wager may be subjected to amount limitations, such as minimums and/or maximums (e.g., limited to an amount equal to the amount of the ante wager), and may be received prior to revealing any cards potentially at play in the round of the game.

As another example, one or more side wagers may be received. A side wager may be optional, subjected to minimums and/or maximums, and may be received prior to revealing any cards potentially at play in the round of the game. In other embodiments, however, one or more cards (player or dealer) may be revealed prior to acceptance of the side wager.

For example, and without limitation, a side wager may be designated as a “PAIR PLUS®” (by SHFL entertainment, Inc.) side wager, designated as a wager against a paytable and for which a winning condition is a player hand rank of at least one pair. As another example, and without limitation, one of the side wagers may be designated as a “Card Bonus” wager, designated as a wager against a paytable and for which a winning condition is based on a rank of a hand derived from a combination of the cards of the player hand and the dealer hand, referred to herein as a “combined rank.” For example, in embodiments in which each of the player hand and the dealer hand consist of three cards, for a total of six cards, the combined rank is the rank of all or some cards from the total six cards. As a more particular nonlimiting example, the Card Bonus wager may be a “6 Card Bonus” wager, with the combined rank being a rank of a best five-card hand derived from the six cards of the combination of a three-card player hand and a three-card dealer hand.

In some embodiments, one acceptable side wager may be a progressive side wager, designated as a wager for which a winning condition is, e.g., a predetermined hand combination or premium hand composition. A payout on the progressive side wager may be based on a percentage of a progressive pot, on a paytable, or on both. In some embodiments in which progressive side wagers are acceptable, acceptance of the progressive side wager may not only qualify a player for the potential progressive payout, but may also qualify the player for a potential “envy” payout in the event of a progressive payout being paid to another participating player.

In some examples of the methods according to the present disclosure, all wagers, including optional side wagers, except for the ante, remain in play when the dealer hand does not qualify. For example, in some embodiments, the dealer hand must be a queen high, otherwise the ante bet is returned to the player. In one form of the methods of the present disclosure, a player may not win a progressive payout on an optional side bet unless the dealer hand qualifies.

At least one card may be dealt for a player hand, as indicated at operation 104 of FIG. 1. Dealing the at least one card may not complete the player hand, such that operation 104 forms only a partial player hand. In embodiments in which the wagering game is configured as a three-card poker game, the administrator (e.g., the dealer) may deal one or two player cards to form a partial player hand. For example, two player cards may be dealt to each player position.

The administrator may allow the player to review the partial player hand of cards. In some embodiments, the wagering game may be a poker-based game, such as a stud poker-based game, wherein no cards are discarded and replaced with draw cards. In such embodiments, neither the dealer nor the player is given an opportunity to try to replace any of the cards once dealt. In other draw poker embodiments, the dealer may deal at least one additional card to be used to form a best poker hand from fewer than the dealt number of total cards.

In some embodiments, the player cards may be dealt face-up, particularly if the wagering game involves a head-to-head challenge between only two participants (one of whom takes the role of the “dealer”). In other such embodiments, the player cards may be dealt face-down, with the values thereof being concealed to all but the player for whom the cards are designated such that each player in a round of the game is made aware of the values of that one player's cards at this stage in the game.

Before, concurrently with, or after dealing the at least one player card for the player hand (operation 104), the dealer may deal a number of cards for the dealer hand, defining a complete hand, as indicated at operation 106. This dealing operation may complete the dealer hand, such that the dealer hand consists of the number of cards dealt at operation 106. In embodiments in which the wagering game is configured as a three-card poker game, three cards may be dealt to form the dealer hand.

The dealer hand is exposed to the player, as indicated at operation 108. Exposing the dealer hand to the player may include dealing the cards for the dealer hand face up, such that operations 106 and 108 are carried out simultaneously. In other embodiments, the cards for the dealer hand may be dealt to be, initially, face down and then thereafter exposed to the player, such that operations 106 and 108 are carried out sequentially.

After the dealer hand has been exposed to the player, a game play election event is administered, as indicated at operation 110. A set of player game play options is provided to the player. The player game play options include a play wager option and may also include a fold election option. In other embodiments, the player may check. When the player checks, the player continues to play without additional betting, and the player is prohibited from folding. A set of player game play options can include both a check and fold option or could include a check option but not a fold option. When the game play includes a checking option, administration of the game may continue on other wagers already accepted (e.g., the ante wager, the blind wager, bonus wagers) without receiving a play wager or fold election from the player. In any case, the administrator provides the player with an opportunity to place a play wager after knowledge of the complete dealer hand and knowledge of a partial player hand.

The play wager may be subjected to amount limitations, such as minimums and/or maximums as dictated by the house. Play wagers may also have limits on the multiples of the ante wager that are permitted. For example, in some embodiments, the play wager may be limited to a particular integer multiple of the ante wager (e.g., limited to two times (2×) the ante wager, limited to three times (3×) the ante wager, or limited to one times (1×) the ante wager), limited to a range of multiples of the ante wager (e.g., limited to between one times (1×) and two times (2×) the ante wager, limited to between one times (1×) and three times (3×) the ante wager, or limited to between some other minimum multiple and maximum multiple of the ante wager), limited to a particular value amount (e.g., limited to $1.00, limited to $5.00, limited to $20.00, etc.) regardless of other amounts wagered, limited to a range of particular values (e.g., limited to between $1.00 and $5.00, limited to between $5.00 and $10.00, etc.) regardless of other amounts wagered, or some combination thereof (e.g., limited to up the lesser of two times (2×) the ante wager and $20.00).

Regardless of the player game play options that are part of the set, the administrator accepts from the player an election that is selected, by the player, from the predefined set of options. Only one election, selected from the set, may be made and accepted by the administrator. In other embodiments, however, more than one election may be selected from the set and accepted by the administrator.

Should the player select the fold election option from the set, the administrator accepts the fold election, and the player may be disqualified from placing a play wager. Acceptance of the fold election may also trigger resolution of the ante wager, or the ante wager and the blind wager, such that acceptance of the fold election may be followed by retaining the ante wager or retaining the ante wager and the blind wager. Acceptance of the fold election, therefore, may disqualify the player from a potential payout on the ante wager, the blind wager, and the play wager. In some embodiments, one or more bonus wagers, if earlier accepted, may not be impacted by acceptance of the fold election. In other embodiments, one or more bonus wagers may also be retained after acceptance of the fold election.

Should the player select the play wager option from the set, the administrator accepts the play wager. Acceptance of the play wager may qualify the player for a potential payout on the play wager as well as retain the player's qualification for potential payouts on the ante wager and the blind wager.

In some embodiments, following acceptance of the play wager, cards may be discarded, additional cards may be dealt, wagers may be raised, side wagers may be placed, or the like, in manners known in the art. In some embodiments, no additional dealer cards are dealt, no cards are discarded, and no additional wagers are accepted during the completion of the round of the wagering game.

In some embodiments, acceptance of the play wager may trigger completion of the player hand, e.g., by dealing at least one card to complete the player hand. The additional card (or cards) may be designated as a “community card,” i.e., a card that is available for play by more than one participant. In embodiments in which the dealer hand was completed before administration of the game play election event (operation 110), e.g., when the cards for the dealer hand were initially dealt (operation 106), the community card (or cards) dealt to complete the player hand may not be available for play by the dealer. Therefore, the additional card (or cards) dealt as a community card may be a card (or cards) available for use by the player as well as by another player participating in the round of the wagering game and from whom the play wager was accepted. In embodiments in which the wagering game is configured as a three-card poker game and in which two player cards were dealt for the partial player hand at operation 104, one community card may be dealt to complete the player hand at operation 112. Thus, after the administration of the game play election event, only one additional card may be dealt for any and all accepted play wagers in the round of play. This may enable the administration of the wagering game to be faster than those in which cards must be dealt, separately, to each play-wager-participating player. Thus, embodiments of the present disclosure promote a quick administration of the round of the game and avoid delays that may lead to player boredom and disinterest and that may lower the administrator's (e.g., the gaming establishment's) return per period of time on the wagering game.

In other embodiments, players are dealt an initial one-card hand, at operation 104, and two community cards, one additional player card and one community card, or two additional player cards are later dealt. In other examples of the methods according to the present disclosure, wherein players and the dealer receive a different number of cards, part of or none of the player cards may be community cards. In other embodiments, wherein community cards are dealt, at least one of the community cards may be used to complete the dealer hand.

All accepted wagers may then be resolved, as indicated at operation 114, which includes resolving the ante wager. Resolving the ante wager may be based, at least in part, on a rank of the player hand, a rank of the dealer hand, or both. For example, in embodiments in which the wagering game is a three-card poker-based game, a three-card poker rank of the player hand may be determined and a three-card poker rank of the dealer hand may be determined and compared with one another. A three-card poker ranking system may be utilized in which hands rank, from highest rank to lowest rank, as follows: straight flush, three-of-a-kind, straight, flush, pair, and high card. In other embodiments, wherein different numbers of cards form a final player and dealer hand, a four-card, five-card, or other-card ranking system may be utilized. Although the number of cards in the hands may differ in different embodiments, it is preferred that the final dealer hand and final player hands have an equal number of cards.

In some embodiments, the number of cards dealt to complete the dealer hand and dealt to complete the player hand may not include any excess cards. Therefore, all cards dealt for the dealer hand and all cards dealt for the player hand (e.g., including the at least one hole card and the at least one community card) are used to determine the rank of the respective hand. In other embodiments, in which either or both of the player hand and the dealer hand have excess cards, fewer than all available cards may be utilized to determine the player hand rank and the dealer hand rank.

Resolving the ante wager based on rank of hands may include comparing a rank (e.g., a poker rank) of the player hand to a rank (e.g., a poker rank) of the dealer hand, with a player hand rank exceeding the dealer hand rank being at least one prerequisite to meeting a winning condition of the ante wager, the blind wager, and the play wager, respectively.

In some embodiments, for at least one wager accepted, a winning condition may include not only the player hand rank exceeding the dealer hand rank, but the dealer hand rank at least equaling a predetermined minimum qualifying rank. That is, the dealer hand may be required to “qualify” for a winning condition to be met. The predetermined minimum qualifying rank may be, for example and without limitation, a rank of queen-high, king-high, ace-high, one pair, etc.

In embodiments requiring dealer qualification, a winning condition for the ante wager may be met by the player hand rank exceeding the dealer hand rank and the dealer hand rank exceeding the predetermined minimum qualifying rank, provided no fold election was accepted from the player. The ante wager may push (i.e., a “push condition” may be met, and the ante wager returned to the player) if the dealer hand rank does not at least equal the predetermined minimum qualifying rank or if the dealer hand rank at least equals the predetermined minimum qualifying rank and equals the player hand rank, provided, in either case, that the fold election has not been received from the player. The ante wager may be retained by the administrator (i.e., a “losing condition” may be met) if the dealer hand rank at least equals the predetermined minimum qualifying rank and the dealer hand rank exceeds the player hand rank. As described above, acceptance of the fold election from the player, during the round of the wagering game, is also a losing condition triggering the administrator's retention of the ante wager. In such case, resolving the ante wager (as part of operation 114) is accomplished during the round of the wagering game. Thus, in some embodiments, the ante wager may win if the player does not fold and the player hand beats a qualifying dealer hand; may lose if either the player folds or the player hand is beaten by a qualifying dealer hand; or may push if the player does not fold and either the dealer hand does not qualify or the dealer hand qualifies and ties the player hand. Each of the winning, losing, and push conditions for the ante wager may be predefined and provided by the administrator prior to administration of the round of the wagering game.

In some embodiments, the dealer hand need not “qualify,” i.e., need not have at least a minimum rank, in order to fully resolve the wagers as discussed above. In such embodiments, then, the dealer may be said to “always qualify.” In other embodiments, however, the dealer hand may be required to at least meet a predetermined minimum qualification rank else the ante wager and any other wagers received before evaluation of the dealer hand for qualification may be returned to the player or retained by the dealer in accordance with predetermined house rules.

In a “push” condition, the ante wager may trigger the administrator to return the ante wager to the player. For example, the player and dealer hand may have an equal rank, creating a push condition. Meeting any of the losing conditions on the ante wager may trigger the administrator to retain the ante wager. However, meeting a win condition on the ante wager may trigger paying the player a payout on the ante wager of, for example, an even money payout based on the amount of the ante wager. For a nonlimiting example, an ante payout may be a 1:1 payout (e.g., a payout equaling the amount of the respective one of the ante wager and the play wager).

In embodiments in which wagers in addition to the ante wager were accepted, those other wagers may also be resolved concurrently with or subsequent to resolving the ante wager at operation 114. In some such embodiments, resolving other wagers may not be impacted by the dealer qualification consideration for resolving the ante wager.

In embodiments in which a blind wager was accepted, the blind wager may be resolved during operation 114. The blind wager may be resolved based, at least in part, on the player hand rank and the dealer hand, e.g., by determining whether the rank of the player hand (which may include the same hand composition on which resolution of the ante wager was based) exceeds the rank of the dealer hand. In some embodiments, a winning condition for the blind wager may be met by the player hand rank exceeding the dealer hand rank and the player hand meeting a predetermined blind minimum rank (e.g., a flush, a pair, etc.), provided the fold election was not received from the player. A push condition for the blind wager may be met when the player hand rank equals the dealer hand rank or the player hand rank exceeds the dealer hand rank but the player hand rank falls below a predetermined blind minimum winning rank, provided, in either case, that the fold election has not been accepted from the player. A losing condition may be met by the dealer hand rank exceeding the player hand rank. As described above, acceptance of the fold election from the player, during the round of the wagering game, is also a losing condition triggering retention of the blind wager. In such case, resolving the blind wager (as part of operation 114) is accomplished during the round of the wagering game. Thus, in some embodiments, the blind wager may win if the player does not fold and the player hand beats the dealer hand and at least meets the blind minimum rank; may lose if either the player folds or the player hand is beaten by the dealer hand; or may push if the player does not fold and the player hand either ties the dealer hand or beats the dealer hand while not at least meeting the blind minimum rank. Each of the winning, losing, and push conditions for the blind wager may be predefined and provided by the administrator prior to administration of the round of the wagering game.

Meeting a push condition on the blind wager may trigger the administrator to return the blind wager to the player. Meeting any of the losing conditions on the blind wager may trigger the administrator to retain the blind wager. However, meeting a win condition on the blind wager may trigger paying the player a payout on the blind wager, which payout may be defined by a paytable and may be based, e.g., at least in part on the player hand rank (i.e., on the rank of the winning hand). For example, the blind payout may be an odds payout (i.e., a multiple of the amount of the blind wager), such as Table I below, for a three-card poker-based wagering game. In some embodiments, as indicated in Table I, the blind wager may at least push if the player hand rank exceeds the dealer hand rank.

TABLE I

| Player Hand Rank | Odds |
|---|---|
| Straight Flush | 100 to 1 |
| Three-of-a-kind | 29 to 1 |
| Straight | 10 to 1 |
| Flush | 2 to 1 |
| Pair | 1 to 1 |
| Other hands | Push |

Resolving all accepted wagers (operation 114) further includes resolving the play wager if the play wager was accepted as the player's election from the set of player game play options during operation 110. The play wager may be resolved based, at least in part, on the player hand rank and the dealer hand rank, e.g., by determining whether the rank of the player hand (which may include the same hand composition on which resolution of the ante wager was based) exceeds the rank of the dealer hand. In some embodiments, a winning condition for the play wager may be met by the player hand rank exceeding the dealer hand rank. A push condition for the play wager may be met by the player hand rank equaling the dealer hand rank. A losing condition may be met by the dealer hand rank exceeding the player hand rank. As described above, acceptance of the fold election during operation 110, would prohibit the acceptance of the play wager; therefore, the acceptance of the fold election during operation 110 would avoid resolving the play wager during operation 114. Thus, in some embodiments, the play wager may win if the player does not fold and the player hand beats the dealer hand; may lose if the player hand loses to the dealer hand; or may push if the player hand ties the dealer hand. Each of the winning, losing, and push conditions for the play wager may be predefined and provided by the administrator prior to administration of the round of the wagering game.

Meeting a push condition on the play wager may trigger the administrator to return the play wager to the player. Meeting the losing condition on the play wager may trigger the administrator to retain the play wager. However, meeting a win condition on the play wager may trigger paying the player a payout on the play wager.

According to embodiments described, the play wager payout may pay a variety of odds payouts for different predetermined hand combinations. This feature is believed to be novel and advantageously awards players higher payouts with higher-ranking hands that also beat the dealer hand. Predetermined hand combinations and corresponding payout odds may be defined by a paytable and may be based, e.g., at least in part on the dealer hand rank (i.e., on the rank of the losing hand). For example, the play payout may be an odds payout (i.e., a multiple of the amount of the play wager), such as in Table II below, for a three-card poker-based wagering game. In some embodiments, as indicated in Table II, the play wager may at least pay 1:1 if the player hand rank exceeds the dealer hand rank.

TABLE II

| Dealer Hand Rank | Odds |
|---|---|
| Straight flush | 400 to 1 |
| Three-of-a-kind | 300 to 1 |
| Straight | 20 to 1 |
| Flush | 7 to 1 |
| Pair | 2 to 1 |
| Other hands | 1 to 1 |

In embodiments in which a wager other than the ante wager, the blind wager, and the play wager, (e.g., a bonus wager, a progressive side wager) has been accepted from the player, the other wager(s) may be resolved during operation 114.

In embodiments in which a bonus wager designated as a “PAIR PLUS®” wager has been accepted, the PAIR PLUS® wager may be resolved by again considering a rank of the player hand. The PAIR PLUS® wager may be resolved regardless of whether or not the fold election was received from the player. In other words, folding during operation 110 does not impact the PAIR PLUS® wager. In some such embodiments, a winning condition for the PAIR PLUS® wager may be met by the player hand rank at least equaling a predetermined minimum PAIR PLUS® rank (e.g., a pair, an ace-high, etc.). There may be no push condition. A losing condition may be met by the player hand rank falling below the predetermined minimum PAIR PLUS® rank. Thus, in some embodiments, the PAIR PLUS® wager may win if the player hand at least matches a minimum PAIR PLUS® rank, and otherwise the PAIR PLUS® wager loses.

Meeting a losing condition on the PAIR PLUS® wager may trigger the administrator to retain the PAIR PLUS® wager. However, meeting a winning condition on the PAIR PLUS® wager may trigger paying the player a payout on the PAIR PLUS® wager, which payout may be defined by a paytable and may be based, e.g., at least in part on the player hand rank. (Thus, the PAIR PLUS® wager may be a wager against a paytable, not a wager against the dealer.) For example, the PAIR PLUS® payout may be an odds payout (i.e., a multiple of the amount of the PAIR PLUS® wager), such as in Table III below, for a three-card poker-based wagering game.

TABLE III

| Player Hand Rank | Odds |
|---|---|
| Straight flush | 40 to 1 |
| Three-of-a-kind | 30 to 1 |
| Straight | 6 to 1 |
| Flush | 3 to 1 |
| Pair | 1 to 1 |

In embodiments in which a bonus wager designated as a “Card Bonus” wager (e.g., a “6 Card Bonus”) wager has been accepted, the Card Bonus wager may be resolved, during operation 114, by considering a rank of a combination of cards from both the player hand and the dealer hand. For example, in embodiments in which the wagering game is configured as a three-card poker game, the six cards between the player hand (three cards) and the dealer hand (another three cards) may be evaluated to determine a best five-card poker rank. The Card Bonus wager may be resolved regardless of whether or not the fold election was received from the player. A winning condition for the Card Bonus may be met by the combined rank at least equaling a predetermined minimum bonus rank (e.g., a three-of-a-kind, a straight, etc.). There may be no push condition. A losing condition may be met by the combined rank falling below the predetermined minimum bonus rank. Thus, in some embodiments, the Card Bonus wager may win if the best (e.g., five-card) poker hand formed from the combination of cards from the player hand and dealer hand at least matches a minimum bonus rank, and otherwise the Card Bonus wager loses.

Meeting a losing condition on the Card Bonus wager may trigger the administrator to retain the Card Bonus wager. However, meeting a winning condition on the Card Bonus wager may trigger paying the player a payout on the Card Bonus wager, which payout may be defined by a paytable and be based, e.g., at least in part on the combined rank. Thus, the Card Bonus wager may be a wager against a paytable, not a wager against the dealer.

In embodiments in which a progressive side wager has been accepted, the progressive side wager may be resolved, during operation 114, by again considering a rank of at least the player hand. In some embodiments, acceptance of the fold election during operation 110 may disqualify the player from a potential progressive or partial progressive payout. Therefore, resolving the progressive side wager, as part of operation 114, may be accomplished during operation 110. In other embodiments, acceptance of the fold election during operation 110 may not impact resolution of the progressive side wager.

In some embodiments, the progressive side wager may be accepted as a fee that is not returned to the player regardless of whether or not a progressive winning condition is met. There may be no push condition.

More than one winning condition may be predefined for the progressive side wager. For example, a first winning condition may be met by the player hand rank equaling a predetermined progressive rank (e.g., a mini royal flush in spades (i.e., A-K-Q of spades), a mini royal flush in another suit, a mini royal flush in any suit). Meeting the first winning condition may trigger the administrator to pay the player a payout based on a percentage of a progressive pot (e.g., 100% of a progressive pot, 20% of the progressive pot, 100% less a seed amount of a progressive pot). A second winning condition may be met by the player hand rank at least meeting a predetermined minimum bonus rank (e.g., a straight, a three-of-a-kind), with meeting the second condition triggering the administrator to pay the player a payout defined by a paytable based, at least in part, on the rank of the player hand. For example, the progressive side payout may be an odds payout (i.e., a multiple of the amount of the progressive side wager), such as in Table IV below (in which a straight is the predetermined minimum bonus rank) or in Table V below (in which a three-of-a-kind is the predetermined minimum bonus rank), for a three-card poker-based wagering game. The paytable may also display the percentage on which a payout for a first winning condition is to be based, as shown in the tables below.

TABLE IV

| Player Hand Rank | Payout |
|---|---|
| A-K-Q Spades | 100% |
| A-K-Q | 500 to 1 |
| Heats/Diamonds/Clubs | |
| Straight flush | 70 to 1 |
| Three-of-a-kind | 60 to 1 |
| Straight | 6 to 1 |

TABLE V

| Player Hand Rank | Payout |
|---|---|
| A-K-Q Spades | 100% |
| A-K-Q | 500 to 1 |
| Hearts/Diamonds/Clubs | |
| Straight flush | 100 to 1 |
| Three-of-a-kind | 90 to 1 |

In some embodiments in which a progressive side wager is acceptable, a third winning condition may be predefined to be met when a participating player (i.e., a player from whom the progressive side wager has been received during the round of the wagering game), other than the player for whom the progressive side wager is being resolved, has been found to have met a qualifying winning condition. For example, if the progressive side wager has been accepted from two players during a round of the wagering game and if one of the two players “hits the progressive,” i.e., has a hand rank that equals the predetermined progressive rank (e.g., the A-K-Q Spades, for Tables IV and V above), the third winning condition is found to be met for the other player. In some embodiments, the other player meeting the first winning condition (e.g., one triggering a 100% payout from a progressive pot for the other player) is the only qualifying winning condition that meets the third winning condition. In other embodiments, the third winning condition may be met if the other player has met either the first winning condition (e.g., one triggering a 100% payout from the progressive pot) or a top payout with the second winning condition (e.g., the A-K-Q Hearts/Diamonds/Clubs in Tables IV and V above).

Meeting the third winning condition on the progressive side wager may trigger the administrator to pay a side payout defined by a paytable and may be based, e.g., at least in part on the hand rank of the other player (i.e., the hand having qualified for the progressive payout under, e.g., the first winning condition or the second winning condition). Therefore, if one of two players, from whom the progressive side wager has been accepted, hits the progressive for a 100% pot payout, the other player wins a payout referred to herein as an “envy” payout. For example, the envy payout may be a fixed amount payout, such as in Table VI below, for a three-card poker-based wagering game in which the progressive side wager is a $1.00 fixed amount wager:

TABLE VI

| Other Player Hand | |
|---|---|
| Rank | Payout |
| A-K-Q Spades | $100 |
| A-K-Q | $25 |
| Hearts/Diamonds/Clubs | |

In some embodiments, if the progressive side wager has been accepted from at least three players in a round of the wagering game and multiple participating players have hit the progressive (i.e., have met the first winning condition or, e.g., the top payout on the second winning condition), the other players may be awarded the envy payout for each of the hit progressives. Therefore, for example, if, during a round of wagering, progressive side wagers have been accepted from players A, B, and C; players A, B, and C have not folded; player A is dealt the A-K-Q of spades and player B is dealt the A-K-Q of diamonds, with player C not having been dealt a mini royal flush, player A may be paid 100% of the progressive pot (per Table IV or Table V above), player B may be paid 500:1 (per Table IV or Table V above), and player C may be paid $100 based on player A's win and another $25 based on player B's win, in addition to any other payouts player C may be awarded for other wagers during the round. In some embodiments, only the top-winning payout for the progressive side wager may be awarded to a single player. In such embodiments, then, player A may not also win $25 for player B's progressive win, and player B may not also win $100 for player A's win. In any case, the envy payout may be based only on another player's hand rank such that a player may not be awarded an envy payout for a progressive win that that player has, himself or herself, won.

In any of the above- or below-described embodiments, the method of administering the wagering game may include dealing additional common cards, dealing additional player cards, and/or designating and dealing wild cards. Nonetheless, all cards available for the dealer hand may be exposed to the player (operation 108) before the administrator provides the player an opportunity to place a play wager (operation 110). Moreover, the player hand may not be completed before the administration of the game play election event (operation 110). Therefore, the play wager determination is based on complete knowledge of the dealer hand and incomplete knowledge of the player hand.

In some embodiments, the dealer hand need not qualify, i.e., need not have at least a minimum rank, in order to fully resolve the wagers as discussed above. In such embodiments, then, the dealer may be said to “always qualify.”

Accordingly, disclosed is a method of administering a wagering game in which a playing device layout is provided. The playing device layout bears at least three distinct wager areas, including an ante wager area, a blind wager area, and a play wager area. The at least three distinct wager areas are defined by separate insignia displayed on the playing device layout. An ante wager, at least partially covering the ante wager area, is accepted from the player. The ante wager is designated to be resolved based on a rank comparison of a player hand rank and a dealer hand rank. A winning ante condition is a prerequisite for paying an ante payout equal to the ante wager, a losing ante condition is a prerequisite for retaining the ante wager, and a push ante condition is a prerequisite for returning the ante wager to the player. The winning ante condition is predefined to be met by a combination of the dealer hand rank at least equaling a predetermined minimum qualifying rank, the player hand rank exceeding the dealer hand rank, and no fold election having been accepted from the player. The losing ante condition is predefined to be met by any of (a) a combination of the dealer hand rank at least equaling the predetermined minimum qualifying rank and the dealer hand rank exceeding the player hand rank, and (b) the fold election having been accepted from the player. The push ante condition is predefined to be met by a combination of no fold election having been accepted from the player and any of (a) the dealer hand rank exceeded by the predetermined minimum qualifying rank, and (b) the player hand rank equaling the dealer hand rank and the dealer hand rank at least equaling the predetermined minimum qualifying rank. A blind wager is also accepted from the player, the blind wager at least partially covering the blind wager area. The blind wager equals the ante wager and is designated to be resolved based on the rank comparison of the player hand rank and the dealer hand rank. A winning blind condition is a prerequisite for paying a blind payout defined by a paytable and based on the player hand rank. A losing blind condition is a prerequisite for retaining the blind wager. A push blind condition is a prerequisite for returning the blind wager to the player. The winning blind condition is predefined to be met by a combination of no fold election having been accepted from the player, the player hand rank exceeding the dealer hand rank, and the player hand rank at least equaling a predetermined blind minimum rank. The losing blind condition is predefined to be met by any of the dealer hand rank exceeding the player hand rank and the fold election not having been accepted from the player. The push blind condition is predefined to be met by a combination of no fold election having been received from the player and any of the player hand rank equaling the dealer hand rank, and the player hand rank exceeding the dealer hand rank and exceeded by the predetermined blind minimum rank.

Two player cards are dealt for the partial player hand, and three cards are dealt for the complete dealer hand, which consists of the three cards. The dealer hand is exposed to the player. After exposing the dealer hand to the player and without yet completing the player hand, a game play election event is administered. The game play election event comprises providing a set of player game play options consisting of the fold election and a play wager equaling two times the ante wager and designated to be resolved based on the rank comparison of the player hand rank and the dealer hand rank. A winning play condition is a prerequisite for paying a play payout defined by a paytable and based on the dealer hand rank A losing play condition is a prerequisite for retaining the play wager. A push play condition is a prerequisite for returning the play wager to the player. The winning play condition is predefined to be met by the player hand rank exceeding the dealer hand rank. The losing play condition is predefined to be met by the dealer hand rank exceeding the player hand rank. The push play condition is predefined to be met by the player hand rank equaling the dealer hand rank. An election, selected by the player from the set of player game play options, is accepted from the player. All accepted wagers are resolved.

### Three Card Poker Exposed^{SM}

In at least one embodiment of a method of administering a wagering game, a three-card poker-based wagering game is administered. A mandatory ante wager and a mandatory blind wager equal to the ante wager are accepted from the player at the start of a round. One or more of optional bonus wagers of a PAIR PLUS® wager, a three-card progressive wager, and a 6 Card Bonus wager may also be accepted at the start of the round.

Two player cards are dealt for the player hand. Three cards are dealt face up for the dealer hand. A game play election event is administered in which the administrator provides a set of player game play options consisting of a fold election and a play wager election, the amount of the play wager limited to two times (2×) the ante wager. The player selects one of the options in the set, and that election is accepted by the administrator. If the fold election was selected by the player, and accepted by the administrator, the ante wager and blind wagers are retained, but the PAIR PLUS® wager and the 6 Card Bonus wager, if accepted, are not yet resolved. In one embodiment, a fold election disqualifies the player from winning a payout on the three-card progressive wager. On the other hand, if the play wager was selected by the player, and accepted by the administrator, a community card is dealt for the player hand. The community card completes the player hand as well as the player hands of any other players participating in the round and from whom play wagers have been received.

The ante wager is then resolved, provided the fold election was not earlier accepted because that acceptance would have already resolved the ante wager. If the player hand rank exceeds the dealer hand rank and the dealer hand rank at least equals a qualifying rank of a queen-high, an ante payout of 1:1 is paid to the player. If the player hand rank is exceeded by a dealer hand rank at least meeting the qualifying rank, the ante wager is retained. If either the dealer hand rank does not at least meet the qualifying rank or the dealer hand rank equals the player hand rank, the ante wager is returned to the player.

The blind wager is also resolved, provided the fold election was not earlier accepted because that acceptance would have already resolved the blind wager. If the player hand rank exceeds the dealer hand rank and the player hand rank is a predetermined winning rank, a blind payout is paid (or the blind wager is returned, i.e., “pushes”) according to Table I based on the player hand rank. If the dealer hand rank exceeds the player hand rank, the blind wager is retained. If the player hand rank equals the dealer hand rank, the blind wager is returned to the player.

If the play wager was accepted, the play wager is resolved. If the play hand rank exceeds the dealer hand rank, a play payout is paid according to Table II, based on the dealer hand rank (i.e., the losing hand rank). If the dealer hand rank exceeds the player hand rank, the play wager is retained. If the player hand rank equals the dealer hand rank, the play wager is returned to the player.

If the PAIR PLUS® wager was accepted, and regardless of whether the fold election was accepted, the PAIR PLUS® wager is resolved. If the player hand rank at least equals a pair, a PAIR PLUS® payout is paid according to Table III, based on the player hand rank; otherwise, the PAIR PLUS® wager is retained.

If the 6 Card Bonus wager was accepted, and regardless of whether the fold election was accepted, the 6 Card Bonus wager is resolved. If the best five-card hand formed from the six-card combination of joining the three-card player hand (the player's two cards and the one community card) and the three-card dealer hand has a combined rank of at least a three-of-a-kind, a card bonus payout is paid according to a predefined table, based on the combined rank; otherwise, the 6 Card Bonus wager is retained.

### Three Card Poker Exposed Progressive^{SM}

In at least one embodiment of a method of administering a wagering game, the three-card poker-based wagering game described above as “THREE CARD POKER EXPOSED^{SM}” is administered with an optional three-card progressive side wager also being accepted from the player.

Acceptance of the fold election disqualifies the player from a potential progressive payout. Moreover, the progressive side wager is retained regardless of whether a progressive winning condition is met. Thus, the progressive side wager is essentially a fee that qualifies the player for a potential progressive payout, provided the player does not fold.

If the play wager was accepted during the play wager interval, the progressive side wager is resolved after completing dealing of the player hand. A progressive payout of 100% of a progressive pot is paid to the player for the player hand rank equaling a mini royal flush of a designated suit, e.g., spades, as per Table VII:

TABLE VII

| Hand | Payout | Envy Bonus |
|---|---|---|
| AKQ of spades | 100% of the | $100 |
| | progressive | |
| AKQ of hearts, | 500 for 1 | $25 |
| diamonds or clubs | | |
| Straight Flush | 70 for 1 | |
| Three of a Kind | 60 for 1 | |
| Straight | 6 for 1 | |

A non-progressive payout, based on a fee (which is not a wager and is therefore not returned even if the player wins), is paid to the player for the player hand rank equaling at least a different high-ranking rank (e.g., a straight, a three-of-a-kind), according to Table VII above.

Another player, from whom the progressive side wager has been accepted, and provided a fold election was not received from the another player, may be paid an envy payout based on the winning player hand rank, according to Table VII above. Multiple such envy payouts are awarded to non-winning other players for multiple progressive-winning hands.

Gaming Table Surface with Layout

With reference to FIG. 2, embodiments of methods for administering wagering games may be carried out with use of a wagering game table having a gaming table surface 200. The gaming table surface 200 (also referred to herein as a “playing device layout”) is provided by the administrator and may include multiple player areas 202, e.g., six player areas 202.

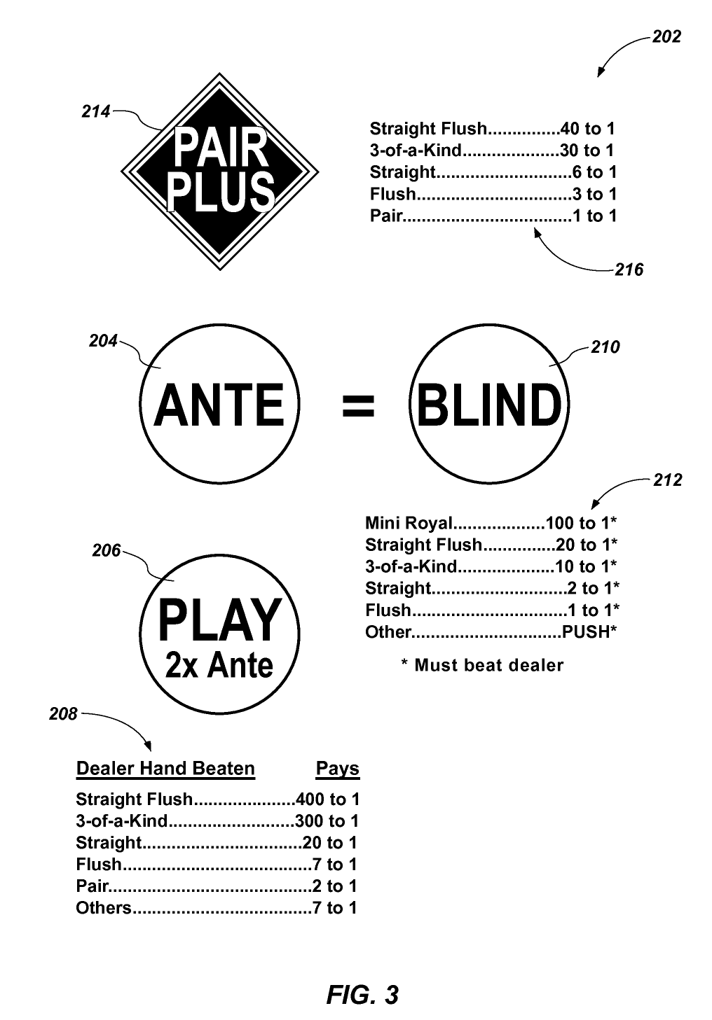

With reference to FIG. 3, illustrated is an enlargement of one of the player areas 202 of FIG. 2. Each player area includes at least three distinct wager areas, including an ante wager area 204, a blind wager area 210, and a play wager area 206. Distinct areas for each acceptable bonus or side wager 214 may also be included on the gaming table surface 200. In administering a round of the wagering game, wagers are received and at least partially cover their respective wager area, with wager areas being left exposed if no respective wager is accepted. The wager areas of wagers that have been retained may be exposed by the administrator.

In some embodiments, such as that illustrated in FIG. 3, the administrator may provide the gaming table surface 200 with the ante wager area 204, the blind wager area 210, and the play wager area 206 designated by distinct circles. Wager areas for optional bonus or side wagers, such as a PAIR PLUS® wager, may be designated by distinct non-circular areas, e.g., a diamond, as with PAIR PLUS® wager area 214.

The gaming table surface 200 may also display paytables, such a paytable for the blind wager (paytable 212), a paytable for the play wager (paytable 208), and a paytable for a bonus wager (paytable 216).

In administering a round of the wagering game, a mandatory ante wager, at least partially covering the ante wager area 204, may be accepted from a player. A mandatory blind wager, at least partially covering the blind wager area 210, may be accepted from the player. The mandatory blind wager is required to be equal to the ante wager.

Dealer cards may be dealt proximate to a point (near to arrow 200 in FIG. 2) around which the player areas 202 are arranged. Player cards may be dealt proximate to the designated wager areas of the player areas 202, e.g., proximate to the PAIR PLUS® wager area 214 of FIG. 3. Community cards may be dealt between the dealer cards and the player cards.

The player is permitted to make an election between folding and placing a play wager, e.g., on the play wager area 206, the play wager at least partially covering the play wager area 206. If a fold election is received from the player, the ante wager and the blind wager are retained, exposing the ante wager area 204 and the blind wager area 210, and the round of play for the player is completed. If an election to place a play wager is received from the player, at least one card to complete the player hand is dealt, e.g., to the community card area.

The wagers are then resolved, as described above, and according to the paytables 208, 212, 216, displayed on the gaming table surface 200.

In some embodiments, the wagering games described herein may be played against the game administrator, i.e., “the house” (i.e., be “house-banked”), which may involve the game administrator (e.g., a casino or other gaming establishment) receiving (via a dealer who may be employed by the administrator) wagers having real-world monetary value, comparing a player hand against a dealer hand, distributing payouts having real-world monetary value to winning players, and retaining lost wagers. For example, in embodiments above, all of the accepted ante, blind, play, and bonus/side wagers may have real-world monetary value and all paid payouts on the wagers may have real-world monetary value. The ante, blind, and play wagers may be retained by the administrator if the fold election is accepted. Any accepted wager may be retained by the administrator if a losing condition for the respective wager is met. Payouts for any winning condition may be paid by the administrator. Such “house-banked” embodiments may be implemented in the form of a live table game, in a virtual table game, in an electronic game, or in an online game configuration (e.g., over a network).

In other embodiments, the wagering games, or at least one wager associated with the wagering game, may involve a player acting as banker, accepting wagers having real-world monetary value, issuing payouts having real-world monetary value, and retaining lost wagers (i.e., be “player-banked”). More specifically, player-banked games may be administered live in a casino or other gaming establishment, such as in a card room, utilizing physical cards and betting chips. The banker (who could otherwise be a player in another round and who may not be an agent of the gaming establishment) retains wagers lost by the players, and the casino or other gaming establishment may collect a player entrance fee or a rake on each wager from the participating players, including the banker.

In other embodiments, that may be implemented as online play, the wagering games, or at least one wager associated with the wagering game, may be administered as an at least partially “pooled pot” embodiment, with payouts on wagers being paid from a pot and losses on wagers being collected into the pot and eventually distributed to one or more players. Such pooled pot embodiments may include a player-pooled progressive embodiment, in which a pot is eventually distributed when a predetermined progressive-winning hand combination or composition is dealt. Pooled pot embodiments may also include a dividend refund embodiment, in which at least a portion of the pot is eventually distributed in the form of a refund distributed, e.g., pro-rata, to the players who contributed to the pot.

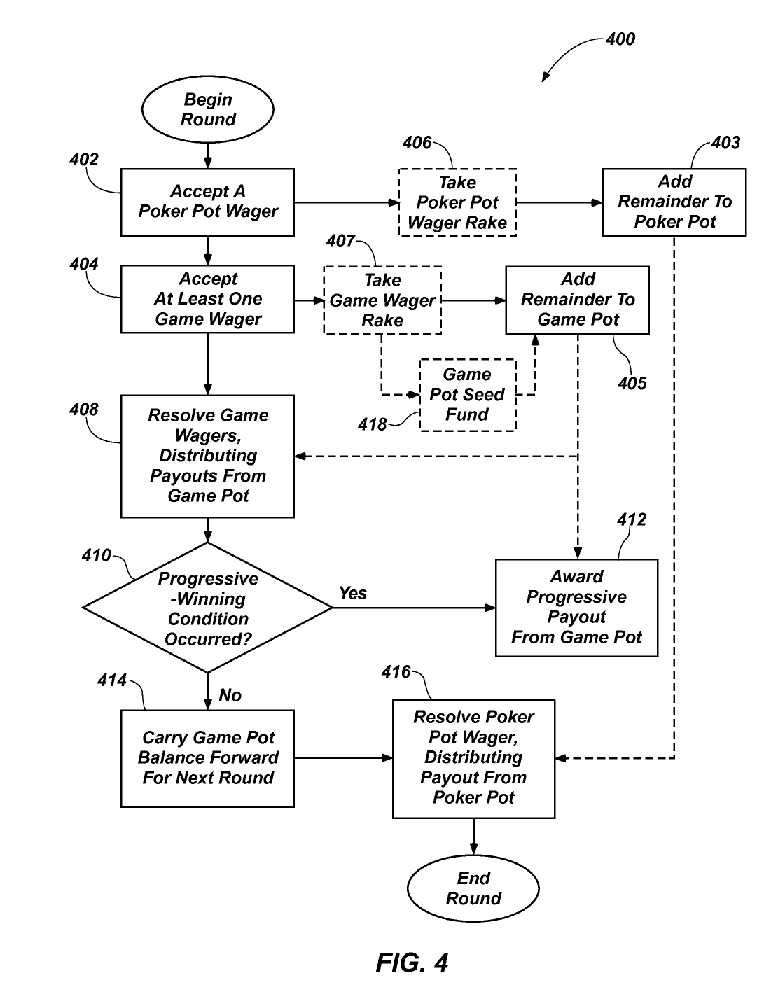

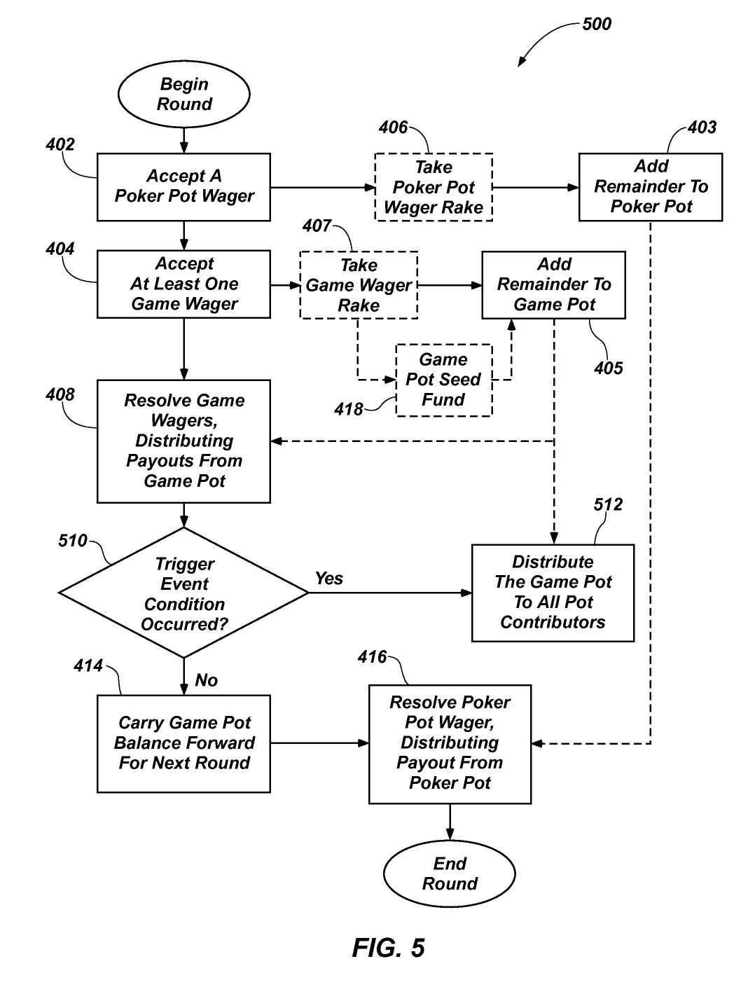

In some pooled pot embodiments, due to regulatory constraints, the game administrator may not obtain profits from chance-based events, occurring in the wagering games and resulting in lost wagers. Instead, lost wagers may be redistributed back to at least one player, which may enable the wagering games to qualify as nonbanked games under Class II of the Indian Gaming Regulatory Act. The wagering games may, in some jurisdictions, be offered over the Internet, or another network, as an online poker wagering game. To profit from the wagering game, the game administrator may retain a commission, such as, for example, a player entrance fee or a rake taken on wagers, or on payouts, such that the amount obtained by the game administrator in exchange for hosting the wagering game is limited to the commission and is not based on the chance events occurring in the wagering game itself. Specific, illustrated mechanisms for redistributing the lost wagers back to players are described in connection with FIGS. 4 and 5.

Referring to FIG. 4, shown is a flowchart diagram of a method 400 of administering a wagering game, which may be a pooled pot embodiment; such as a player-pooled progressive embodiment. The method 400 includes accepting a first mandatory wager, referred to herein as a “poker pot wager,” as indicated at operation 402. At least a portion of the poker pot wager is added to a poker pot, as indicated at operation 403. The poker pot wager may be later resolved by comparing player hands and awarding the poker pot, or at least a portion thereof, to the player or players associated with, for example, the highest-ranking poker hand or hands of all other participating player hands from the round of the wagering game. For example, a player holding, e.g., a mini royal flush, in a three-card poker-based wagering game, that outranks the player hands of all other participating players may be awarded at least a portion of a poker pot in a player-pooled progressive embodiment.

The poker pot may be a non-progressive pot in that all or substantially all of the poker pot may be distributed at the conclusion of each round of administration of the wagering game. In some embodiments, the poker pot wager may be a mandatory wager to qualify the player for play of the underlying wagering game. In other embodiments, the poker pot wager may be optional, and the wagering game may be administered with a player without receiving the poker pot wager and without qualifying the player for a potential payout from the poker pot.

The dealer may also accept at least one game wager, as indicated at operation 404. The game wagers may include, for example, a base game wager (e.g., ante wagers, blind wagers, play wagers, raises, and other wagers made on the underlying wagering game) and/or a side wager or wagers. More specifically, the game wagers may comprise, for example, any or all of the ante wager, the blind wager, the play wager, the PAIR PLUS® wager, the Card Bonus wager, and, in some embodiments, the progressive side wager, described above. The at least one game wager may be accepted, for example, by performing any of the acts for accepting wagers described previously in connection with FIG. 1. At least a portion of the at least one game wager is added to a game pot, as indicated at operation 405, which may be a progressive pot.

Optionally, a third pot wager may be accepted and added to at least a third pot. The third pot may be separate from either or both of the poker pot and the game pot. For example, the poker pot, the game pot, and the third pot may include chips located in separate areas on a gaming table, when the wagering game is conducted live in a casino. As another example, the poker pot, the game pot, and the third pot may be displayed as separate amounts on one or more video displays (e.g., a gaming screen 606 (FIG. 6), a playing surface 704 (FIG. 7), a player interface 716a through 716g (FIG. 7), a dealer interface 718 (FIG. 7), an upright display 730 (FIG. 7), a player interface area 832a through 832e (FIG. 8), a dealer screen 860 (FIG. 8), a community card screen 864 (FIG. 8), a display of a user device 920 (FIG. 9), or a display 1018 (FIG. 10)) (e.g., a monitor) controlled by one or more processors (e.g., a control processor 610 (FIG. 6), a local game processor 714a through 714g (FIG. 7), a central game processor 728 (FIG. 7), a control processor 897 (FIG. 8), a processor of a gaming system 900 (FIG. 9), or a processor 1002 (FIG. 10)) and may be maintained in separate accounts when the wagering game is conducted online or in another electronic format.

In some embodiments, acceptance of the at least one game wager qualifies a player to be eligible to win an award in addition to the payouts available from the underlying game (i.e., the payouts on the ante, blind, play, and bonus/side wagers), such as, for example, a progressive payout (e.g., a progressive jackpot awarded to one or more qualifying players), which progressive payout may be in the form described above. Therefore, in such embodiments, a progressive wager (such as the progressive side wager described above) may be received, as one of the at least one game wagers, in addition to the other game wagers received from the player, such as the ante, blind, play, and bonus wagers.

In some embodiments, the progressive wager may be a mandatory wager to qualify the player for play of the underlying wagering game. In other embodiments, the progressive wager may be optional, and the wagering game may be administered with a player without receiving the progressive wager, in addition to the other game wagers, from the player and without qualifying the player to be eligible to win the progressive payout from the game pot.

In some embodiments, the poker pot wager and the at least one game wager may be received as indistinct wagers, with a portion thereof being designated for the poker pot (a non-progressive pot) and another portion being designated for the game pot (a progressive pot).

The poker pot wager and the at least one game wager (including the progressive wager, depending on the embodiment) may be accepted, for example, by performing any of the acts for accepting wagers described previously in connection with FIG. 1

In some embodiments, the game pot may be a pooled or linked pot. For example, the game pot may include one or more game wagers accepted from multiple concurrent wagering games. As another example, the game pot may include pooled progressive wagers from those wagering games currently being played and/or may include accumulated game wagers from past wagering games. As specific, nonlimiting examples, the game pot may include all game wagers accepted from a group of tables (e.g., a group of electronic gaming tables) or other local wagering game administration devices at a casino, from multiple groups of remote devices connected to network gaming architecture, or both. In other embodiments, the game pot may not be pooled, and awards for the game wager may be limited to the amounts wagered at a respective table (e.g., electronic gaming table), local wagering game administration device, or group of remote devices.

The gaming establishment (e.g., the “house”) may take a “rake,” (e.g., a commission for the house) on at least one wager, such as the poker pot wager, as indicated at operation 406, the at least one game wager, as indicated at operation 407, or both. In some embodiments, therefore, a rake may be taken on all wagers or any wager. For example, the house may collect a portion of the poker pot wager at the time the poker pot wager is placed, with the remainder added to the poker pot. Additionally or alternatively, the house may collect a portion of the game wagers at the time the game wagers are placed, with the remainders added to the game pot.

The rake may comprise, for example, a fixed percentage of the wagers. More specifically, the percentage of the wagers collected for the rake may be, for example, greater than a theoretical house advantage for the underlying game. As another example, the rake may be less than an average house advantage for play of the wagering game by all players, including average and sub-average players, which may be calculated using a historical house advantage for the wagering game (e.g., a house advantage for the wagering game over the last five, ten, or fifteen years for a given casino or other gaming establishment). As specific, nonlimiting examples, the percentage of the wagers (i.e., either or both of the poker pot wager and the at least one game wager) collected for the rake may be between 3% and 8%, between 4% and 7%, or between 5% and 6%. In other embodiments, the portion of the wagers collected for the rake may comprise a variable percentage of the wagers or may comprise a fixed quantity (e.g., a flat fee) irrespective of the total amount for the wagers, a fixed percentage with a cap, or a time-based fee for increments of time playing the wagering game. Thus, in lieu of, or in addition to, a rake taken on one or more wagers or from winnings, the house may be compensated in a number of other ways, including, without limitation, a flat fee per round of play, a percentage of wagers made with or without a cap, rental of a player “seat,” or otherwise as is known in the gaming art. All such compensation may be generally referred to as a “commission.”

All profits for the house may be made from the rake (or rakes or other commission) in some pooled pot embodiments. In such embodiments, wagers in excess of the rake are distributed either in the form of, for example, a progressive payout (as in a “player-pooled progressive” embodiment (FIG. 4)), a dividend refund (as in a “dividend refund” embodiment (FIG. 5)), or some combination thereof. Thus, the profits for the house are limited. Such limiting of profits for the house and redistribution of wagers back to one or more players may increase the attractiveness of the wagering game to both inexperienced and highly skilled players. Because the amount earned by the house is known, highly skilled players may perceive that their skill will enable them to increase winnings, and inexperienced players may be enticed by the possibility of winning or otherwise earning a portion or all of one or more of the pots. In other embodiments, the house may make profits on the rake and on losses from one or more of the wagers (e.g., the aforementioned ante wager, blind wager, play wager, PAIR PLUS® wager, Card Bonus wager, and progressive side wager), including losses resulting from optimal and suboptimal play.

The rake may be maintained in a rake account, and profits for the house may be deducted from the rake account. When and if taken from the poker pot wagers, the poker pot rake (operation 406) may be taken by, for example, electronically transferring funds from the poker pot wagers or the poker pot itself to a poker pot rake account (e.g., as instructed by a game server 906 (see FIG. 9) using casino account servers 910 (see FIG. 9)) or physically removing or exchanging money or representations of money from the poker pot wagers or the poker pot itself on a live table. Likewise, when and if taken from the game wagers, the game pot rake (operation 407) may be taken by, e.g., electronically transferring funds from the game pot wagers or the game pot itself to a game pot rake account (e.g., as instructed by the game server 906 (see FIG. 9) using casino account servers 910 (see FIG. 9)) or physically removing or exchanging money or representations of money from the game wagers or the game pot itself on a live table.

In some embodiments, the poker pot wager may be accepted (operation 402) at the beginning of a round of administration of the wagering game. One or more of the game wagers may be accepted (operation 404) at the beginning of the round as well, e.g., the ante wager, the blind wager, and one or more bonus wager (e.g., the PAIR PLUS® wager, the Card Bonus wager, and the progressive side wager). In some embodiments, additional game wagers (e.g., the play wager) may be accepted (operation 404), possibly raked (operation 407), and added to the game pot (operation 405) in the intermediate segments of the round of play.

The underlying wagering game may be played as described above, including resolving the game wagers received during the round of play, as indicated at operation 408. For example, the underlying wagering game may be played at least substantially as described previously in connection with FIGS. 1 through 3. Payouts to be distributed, as a result of resolving the game wagers, (e.g., payouts on the ante, blind, play, bonus (e.g., PAIR PLUS®, Card Bonus) wagers), are paid from the game pot.

It is contemplated that only a portion of the game pot may be distributed, at operation 408, in the form of payouts on the underlying game. At least in embodiments in which the game pot is configured as a progressive pot (e.g., if one of the game wagers is a progressive wager), all or substantially all of the remaining portion of the game pot may be designated for a potential progressive payout (e.g., the payouts on the progressive side wager as described above). For example, administering the player-pooled progressive embodiment of the pooled pot method 400 may include determining whether a progressive-winning condition has occurred, as indicated at operation 410. A progressive-winning condition may be predefined as a predetermined winning hand combination being dealt or a premium winning hand composition being dealt. If such a progressive-winning condition has occurred during the round of game administration, a progressive payout may be awarded to the winning-hand-holding player, with the progressive payout being paid from the game pot, as indicated at operation 412. As just one example, a game may pay a progressive payout according to either of Table IV or V and, in some embodiments, also Table VI (regarding the envy payout). If no progressive-winning condition has occurred, a progressive payout may not be paid from the game pot, but, rather, the game pot balance may be carried forward for the next round of play and so on, as indicated at operation 414, until a progressive-winning condition occurs during a subsequent round. Thus, the game pot may not be awarded at the end of each round of play, but may grow during each successive round in which no player is dealt a predetermined winning hand combination or a premium winning hand composition. However, if the underlying game payouts distributed at operation 408, or if a progressive payout is awarded at operation 412, without draining the game pot, the game pot may decrement until such time as the game pot contributions, at operation 405, rebuild the game pot.

A predetermined winning hand combination may comprise, for example, a mini royal flush of any of three predetermined suits out of the four suits of cards, a straight flush, a three-of-a-kind, or a straight, e.g. The hands qualifying as new winning hand combinations may be predetermined at the beginning of each round of play in some embodiments. In other embodiments, new winning hand combinations may be predetermined at the beginning of play and may remain fixed until it is determined that at least one player hand achieves a predetermined winning hand combination, at which time new winning hand combinations may be predetermined. In still other embodiments, the hand combinations qualifying as winning hand combinations may be predetermined at the outset of the wagering game and remain fixed for the duration of the wagering game. The hands qualifying as winning hand combinations may be predetermined at random from a list of possible winning hand combinations, from among a schedule with a fixed rotation of possible winning hand combinations, or using a fixed table of winning hand combinations.

A premium winning hand composition may comprise, for example, a mini royal flush of a predetermined suit out of the four suits of cards. The hand compositions qualifying as premium winning hand compositions may remain fixed throughout the duration of the wagering game or may change during the wagering game. For example, after it has been determined that a player hand has achieved a premium winning hand composition, the hand compositions qualifying as premium winning hand compositions may be made more restrictive or less restrictive. As a specific, nonlimiting example, after identification of a player hand achieving a straight flush, the hand compositions qualifying as premium winning hand compositions may be restricted to royal flushes (e.g., a particular mini royal flush, e.g., a mini royal flush in spades) or may be expanded to include three-of-a-kinds. The hands qualifying as premium winning hand compositions may be predetermined at random from a list of possible premium winning hand compositions, following a schedule with a fixed rotation of possible premium winning hand compositions, or according to a fixed table of premium winning hand compositions.

In embodiments in which the game pot is a progressive pot, the amount awarded from the game pot for achieving a premium winning hand composition may be a progressive payout at least as great as a maximum progressive payout for achieving a predetermined winning hand composition. For example, the entire game pot may be awarded when a player or multiple players are dealt a premium winning hand composition, and only a portion of the game pot may be awarded when a player or multiple players are dealt a predetermined winning hand combination.

Awarding the game pot or a portion of the game pot may comprise crediting a player account with funds from the game pot or may comprise distributing physical money or physical representations of money from the game pot to the player.

Before, between, or after resolving the game wagers (operation 408), determining whether a progressive-winning condition occurred (operation 410), awarding a progressive payout (operation 412), or any combination thereof, the poker pot wager may be resolved, and the poker pot may be awarded to at least one player, as indicated at operation 416. Each successive round of receiving wagers, dealing cards, and resolving wagers may constitute a round of play, and the poker pot may be awarded to at least one player before the end of each round of play. The player to whom the poker pot is awarded may hold the highest ranked hand of all the participating player hands at the table. For example, if a player holds a mini royal flush and outranks all other participating player hands, the dealer may award the poker pot to the holder of the mini royal flush.

Awarding the poker pot or the portion of the poker pot may comprise crediting a player account of each winning player or may comprise distributing physical money or physical representations of money to each winning player.

In some embodiments, an entire amount of the poker pot may be awarded to at least one player before the end of each round of play. In such embodiments, the poker pot may be a non-progressive pot. Awarding the entire poker pot to at least one player at the end of each round of play may enable an online implementation of the wagering game to qualify as a legal form of online gambling under relevant statutes. For example, in games that require a mandatory pot bet that has no house advantage, and all other game wagers are raked with remainders going into a second pot, the game may qualify as “poker” to gaming authorities, especially for online versions of the games. Awarding the entire amount of a poker pot to at least one player at the end of each round of play redistributes lost poker wagers attributable to suboptimal play to other players, rather than to the house. Accordingly, such a wagering game may be particularly attractive to players who perceive themselves as being highly skilled in the wagering game and, therefore, more able to take advantage of suboptimal play by other players.

In some embodiments, a portion of the poker pot may be awarded to at least one player at the end of each round of play (operation 416). For example, the house may take a rake on the poker wager (operation 406), which may still enable the wagering game to qualify as a legal form of online gambling under relevant statutes. The rake taken may comprise, for example, between 1% and 8%, between 2% and 6%, or between 3% and 5% of the poker pot wager. The rake amounts on each wager may be more than, less than, or equal to the rake taken on other wagers in some embodiments.

In still other embodiments, a portion of the poker pot may remain in the poker pot or may be redistributed to another pot (e.g., the game pot) to be awarded in a subsequent round of play as a progressive payout or as a dividend refund (see FIG. 5). In such an example, the portion of the poker pot wager remaining in the poker pot or redistributed to another pot may comprise, for example, a fixed percentage of the poker pot wager, a variable percentage of the poker pot wager (e.g., an odds payout may be awarded and the remainder retained in the poker pot or redistributed to the other pot), or a fixed amount.

In some embodiments involving a no-house-advantage poker pot awarded at the end of each round and a progressive game pot that receives all other game wagers, all players participating in the wagering game from whom the at least one game wager has been received may be eligible to win the game pot or a portion of the game pot. Players who are ineligible to win the poker pot, and players from whom fold indications have been received but from whom one or more other active wagers in play have been received, may be eligible to win the game pot or a portion of the game pot.

In some embodiments, the game pot may be seeded with money from the game pot rake account or a reserve account (as indicated at operation 418) at the beginning of play, after the game pot or a portion of the game pot has been awarded, or both. In some embodiments, a minimum account balance sufficient to cover expected losses is retained when distributing a progressive payout (operation 412) such that no seed money is required in the game pot. For example, the game pot may be seeded from the rake account of the house (operation 418), and the house may maintain an amount of funds in the rake account sufficient to significantly reduce (e.g., to essentially eliminate) the likelihood that any payouts made from the rake account and any seeding amounts withdrawn from the rake account exhaust or overdraw the rake account. In some embodiments, a casino reserve account may be provided to fill the rake account in the event of an overdraw. Such seeding may incentivize players to participate in the wagering game, and specifically to place a game wager (e.g., a progressive wager) to be eligible for the progressive payout from the game pot. In addition, such seeding may reduce the likelihood that the amount of funds in the game pot may be insufficient to cover all the payouts to players. For example, where a player hand achieves a premium winning hand composition in one round of play, a player hand achieves a predetermined winning hand combination in the immediately following round of play, and a fixed odds payout is to be awarded to the player holding the predetermined winning hand combination, the amount seeded to the game pot between those rounds of play may be at least as great as the maximum fixed odds payout awardable for any predetermined winning hand combination. The game pot may be seeded each time the game pot is awarded in its entirety or each time the amount in the game pot is lower than the maximum fixed odds payout.

As a specific, nonlimiting example, a pooled pot wagering game with a player-pooled progressive configuration may comprise, accepting a poker pot wager from all players participating in the round, adding the poker pot wagers to a poker pot, accepting all other wagers in the game (e.g., the ante wager, blind wager, play wager, bonus/side wagers) and adding those to a game pot. All wagers may be raked, and the wagering game administered as described above. Payouts on any of the ante, blind, play, and bonus/side wagers may be paid out of the game pot. The poker pot may be paid to the player holding the highest player hand rank among all the player hand ranks participating during the administration of the round. If a player achieves a mini royal flush of spades, e.g., the player may be paid the entire amount remaining the game pot, less a seed amount, in some embodiments.

Referring to FIG. 5, shown is a flowchart diagram of a method 500 of administering a wagering game, which may be at least partially a pooled pot wagering game, according to a dividend refund embodiment. The method 500 is largely the same as the method 400 of the player-pooled progressive (FIG. 4), with the exception that, rather than determining whether a progressive-winning condition has occurred (operation 410 (FIG. 4)), the method 500 includes determining whether a trigger event condition has occurred, as indicated at operation 510, and, if so, distributing the game pot to one or more past or present players of the wagering game, as indicated at operation 512 (rather than distributing the game pot as a progressive payout as at operation 412 (FIG. 4)). In such embodiment, the game pot may accumulate between rounds of play, and, to periodically reduce the balance, a dividend (e.g., a share of the game pot awarded to each participating player) may be awarded to players from the game pot. Thus, what would otherwise be the profits from lost wagers, less amounts raked by the house, are redistributed back to the players, rather than collected by the house as revenue. Thus, the distribution is not a payout on the underlying game, but a refund.

The game pot, which may include all game pot wagers accepted during the round less any game pot rake taken, may be distributed among a plurality of players upon the occurrence of a predetermined event (referred to herein as a “trigger event”), as indicated at operation 510. The predetermined, trigger event may not be based, for example, on player skill or chance events occurring in the underlying wagering game. The predetermined trigger event may comprise, for example, determination that at least one player participated for a predetermined number of hands; completed a predetermined number of rounds of play at a given table, electronic gaming machine, or remote gaming device; reached a predetermined time limit since play commenced; or reached a predetermined amount within the game pot. The predetermined trigger event or condition may be time-based, pot-based (or pool-based), game-based, or other-based. Further details on pot distributions based on predetermined trigger events and conditions are disclosed in the U.S. patent application Ser. No. 13/871,824, filed Apr. 26, 2013, titled “Distributing Supplemental Pot in Wagering Games Based on Predetermined Event,” the disclosure of which is incorporated herein in its entirety by this reference.

The dividend distributions may be divided at least among players currently participating in the wagering game. In some embodiments, the dividend distributions may also be paid to players who previously contributed to the game pot but who have since ceased participating in the wagering game. In some embodiments, the dividend distributions may not be paid to players from whom contributions to the game pot have not been received since the last dividend distribution was paid. The percentage of the game pot (e.g., all accepted wagers added to the game pot tally, less the rake), refunded to each player as a dividend distribution may be, for example, approximately equal to the percentage of hands won by each player, the percentage of first pot winnings won by each player based on game play, the percentage of total wager amounts received from each player, the proportional number of wagers received from each player, the proportional length of time spent playing the wagering game by each player, or an equal percentage for each player eligible to receive a dividend distribution from the game pot.

The dividend refund may be distributed in the form of a credit made to the receiving players' accounts. In some embodiments, the refund may be paid without concurrently alerting the player, though the refund may be noticeable when and if the player next checks his or her balance in his or her player account.

As a specific, nonlimiting example, a pooled pot wagering game with a player-pooled progressive configuration may comprise, accepting a poker pot wager from all players participating in the round, adding the poker pot wagers to a poker pot, accepting all other wagers in the game (e.g., the ante wager, blind wager, play wager, bonus/side wagers) and adding those to a game pot. All wagers may be raked, and the wagering game administered as described above. Payouts on any of the ante, blind, play, and bonus/side wagers may be paid out of the game pot. The poker pot may be paid to the player holding the highest player hand rank among all the player hand ranks participating during the administration of the round. Administering the wagering game may further comprise determining whether a predetermined trigger event has occurred, such as the completion of a predetermined number of hands, the completion of a predetermined number of rounds of play, the game pot reaching a predetermined limit, or the game pot reaching a predetermined amount. If a predetermined trigger event has occurred, the administrator may distribute the entire game pot, less a seed amount, to all players having contributed to the game pot based on a pro-rata distribution. The refund may be transferred to each player's player account without a simultaneous alert provided to the receiving players.

In some embodiments, wagering games may be administered, e.g., over a network, without players risking money in connection with the wagers (i.e., “play-for-fun” games). Access to play-for-fun wagering games may be granted on a time period basis in some embodiments. For example, upon initially joining the wagering game, each player may automatically be given wagering elements, such as, for example, chips, points, or simulated currency, that is of no redeemable value. After joining, the player may be permitted to place bets using the wagering elements, and a timer may track how long the player has been participating in the wagering game. If the player exhausts his or her supply of the wagering elements before a predetermined period of time has expired, the player may be permitted to simply wait until the period of time passes to rejoin the game, at which time another quantity of the wagering elements may be distributed to the player to permit the player to resume participation in the wagering game.

In some embodiments, a hierarchy of players may determine the quantity of wagering elements given to a player for each predetermined period of time. For example, players who have been participating in the wagering game for a longer time, who have played closest to optimal strategy for the game, who have won the largest percentage of wagers, who have wagered the most in a play-for-pay environment, or who have won the largest quantities of wagering elements from their wagers may be given more wagering elements for each allotment of time than players who have newly joined, who have played according to poor strategy, who have lost more frequently, or who have lost larger quantities of wagering elements. In some embodiments, the hierarchy of players may determine the duration of each allotment of time. For example, players who have been participating in the wagering game for a longer time, who have played closest to optimal strategy for the game, who have won the largest percentage of wagers, or who have won the largest quantities of wagering elements from their wagers may be given shorter allotments of times to wait for an award of more wagering elements than players who have newly joined, who have played according to poor strategy, who have lost more frequently, or who have lost larger quantities of wagering elements. In some embodiments, players who have not run out of wagering elements after the period of time has expired may have the balance of their wagering elements reset for a subsequent allotment of time. In other embodiments, players who have not run out of wagering elements may be allowed to retain their remaining wagering elements for subsequent allotments of time, and may be given additional wagering elements corresponding to the new allotment of time to further increase the balance of wagering elements at their disposal. Players may be assigned to different categories of players, which determine the number of wagering elements awarded. In a given period of time, higher level players, or players who have invested more time playing the game may be allotted more wagering elements per unit of time than a player assigned to a lower level group.

Therefore, in some embodiments, the wagering game may be administered by receiving wagers (e.g., the ante, blind, play, and bonus/side wagers)) of no real-world monetary value, and payouts may be paid without transferring real-world monetary value to the players. Such embodiments, referred to herein as “free play-for-fun” embodiments, are nonetheless contemplated as modes of carrying out the methods described herein.

In some embodiments, referred to herein as “social play-for-fun” embodiments, a player may be permitted to redeem an access token of no redeemable face value, such as, for example, points associated with a player account (e.g., social media account credits, online points associated with a transacting account, etc.), to compress the period of time and receive more wagering elements. The access tokens may be sold or may be given without directly exchanging money for the access tokens. For example, access tokens may be allocated to players who participate in member events (e.g., complete surveys, receive training on how to play the wagering game, share information about the wagering game with others), spend time participating in the wagering game or in a player account forum (e.g., logged in to a social media account), or view advertising. Thus, an entity administering social play-for-fun wagering games may not receive money from losing player wagers or may not take a rake on wagers, but may receive compensation through advertising revenue or through the purchase of access tokens redeemable for time compressions to continue play of the wagering game or simply to increase the quantity of wagering elements available to a player.

After receipt of an indication that a player has stopped participating in a play-for-fun wagering game (e.g., a free play-for-fun embodiment, a social play-for-fun embodiment), any remaining quantities of the wagering elements may be relinquished by the player and retained by the administrator, in some embodiments. For example, receipt of an indication that the player has logged out of a play-for-fun wagering game administered over the Internet may cause any remaining wagering elements associated with a respective player to be lost. Thus, when the player rejoins the play-for-fun wagering game, the quantity of wagering elements given to the player for an allotment of time may not bear any relationship to the quantity of wagering elements held by the player when he or she quit playing a previous session of the wagering game. In other embodiments, upon receipt of an indication that a player has stopped playing, the quantity of wagering elements held by the player at that time may be retained and made available to the player, along with any additional quantities of wagering elements granted for new allotments of time, upon receipt of an indication that the player has rejoined the wagering game.

As a specific, nonlimiting example, a free play-for-fun wagering game may comprise accepting from a player an ante wager of no monetary value. At least one hole card for a player hand is dealt, and a number of cards for a dealer hand is dealt. The dealer hand is exposed to the player. After exposing the dealer hand to the player, a game play election event is administered. During the game play election event, a set of player game play options is provided. The set of player game play options comprises a fold election and a play wager having no monetary value. An election, selected by the player from the set of player game play options, is accepted from the player. After the game play election event, at least one community card is dealt for the player hand. All accepted wagers are resolved without distributing monetary value to the player.

As another specific, nonlimiting example, a social play-for-fun wagering game may comprise accepting from a player a payment for access to engage in the wagering game and providing the player, in return, with a limited time period of access to engage in the wagering game. During the time period, the wagering game may be administered as described above, with accepted wagers holding no real-world monetary value and payouts paid holding no real-world monetary value. At the completion of the limited time period of access, the administrator may offer to sell additional access. Thus, a monetary fee is accepted to provide access to the wagering game, but monetary value is not risked or awarded in the administration of the wagering game.

### Other Game Formats

Various platforms are contemplated that are suitable for implementation of embodiments of wagering games according to the present disclosure. For example, embodiments of wagering games may be implemented such that wagers may be received from one or more players, and game play may be administered with the one or more players according to the rules of the wagering games. For example, wagering games may be implemented on gaming tables, which may include physical gaming features, such as physical cards and physical chips, and may include a live dealer and a shuffler or shoe. More specifically, a live dealer may deal physical cards, evaluate hands, accept wagers, accept player elections, issue payouts, and perform other administrative functions of game play. Some embodiments may be implemented on electronic devices enabling electronic gaming features, such as providing electronic displays for display of virtual cards, virtual chips, game instructions, pay tables, etc. Some embodiments may include features that are a combination of physical and electronic features.

As an example, embodiments of wagering games may be implemented on an individual gaming device, such as a video poker machine, configured to accept wagers and having a display screen and input devices for enabling game play of the wagering games. Such an individual gaming device may be linked with other gaming devices that may be operated, for example, by other players. Some individual electronic gaming devices may be referred to as an individual player “electronic gaming machine” and may be stationary, such as being located on a casino floor. Other individual electronic gaming devices may be portable devices that may be carried to different locations by the player. Portable devices may include both display of the ongoing game play and input reception for game play by a player. Portable devices may, alternatively or additionally, be configured for receiving input from a player while the game play is displayed on a public monitor or other display device. Game play and game outcomes may also be displayed on a portable device.

As previously noted, any of the present methods and games may be played as a live casino table card game, as a hybrid casino table card game (with virtual cards or virtual chips), on a multi-player electronic platform (as disclosed in U.S. patent application Ser. No. 10/764,827, filed Jan. 26, 2004, published as U.S. Patent Application Publication No. 2005/0164759 on Jul. 28, 2005, now abandoned; U.S. patent application Ser. No. 10/764,994, filed Jan. 26, 2004, now U.S. Pat. No. 7,661,676, issued Feb. 16, 2010; and U.S. patent application Ser. No. 10/764,995, filed Jan. 26, 2004, now U.S. Pat. No. 8,272,958, issued Sep. 25, 2012, the disclosure of each of which applications and patents is incorporated herein in its entirety by this reference), on a personal computer for practice, on a hand-held game for practice, or on a legally-authorized site on the Internet.

For example, in one embodiment, the players may be remotely located from a live dealer, and a live dealer and a game table may be displayed to players on their monitors via a video feed. The players' video feeds may be transmitted to the dealer and may also be shared among the players at the table. In a sample embodiment, a central station may include a plurality of betting-type game devices and an electronic camera for each game device. A plurality of player stations, remotely located with respect to the central station, may each include a monitor, for displaying a selected game device at the central station, and input means, for selecting a game device and for placing a bet by a player at the player's station relating to an action involving an element of chance to occur at the selected game device. Further details on gambling systems and methods for remotely-located players are disclosed in U.S. Pat. No. 6,755,741 B1, issued Jun. 29, 2004, titled “Gambling Game System and Method for Remotely-Located Players,” the disclosure of which is incorporated herein in its entirety by this reference, and in connection with FIGS. 9 and 10.

Referring to FIG. 6, illustrated is an example of an individual electronic gaming device 600 (e.g., an electronic gaming machine (EGM)) configured for implementation of embodiments of wagering games according to the present disclosure. The individual electronic gaming device 600 may include an individual player position 602 that includes a player input area 604 configured to enable a player to interact with the individual electronic gaming device 600 through various input devices (not shown). The individual electronic gaming device 600 may include a gaming screen 606 configured to display indicia for interacting with the individual electronic gaming device 600, such as through processing one or more programs stored in memory 608 to implement the rules of game play at the individual electronic gaming device 600. Accordingly, game play may be accommodated without involving physical playing cards, poker chips, and/or live personnel. The action may instead be simulated by a control processor 610 operably coupled to the memory 608 and interacting with and controlling the individual electronic gaming device 600.

Although the figure has an outline of a traditional gaming cabinet, the individual electronic gaming device 600 may be implemented in any number of ways, including, but not limited to, client software downloaded to a portable device, such as a smart phone, tablet, or laptop personal computer. The individual electronic gaming device 600 may also be a non-portable personal computer (e.g., a desktop or all-in-one computer) or other computing device. In some embodiments, client software is not downloaded but is native to the device or is otherwise delivered with the device when distributed to a player.

A communication device 612 may be included and operably coupled to the central processor 610 such that information related to operation of the individual electronic gaming device 600, information related to the game play, or combinations thereof may be communicated between the individual electronic gaming device 600 and other devices (not shown) through a suitable communication media, such, as, for example, wired networks, Wi-Fi networks, and cellular communication networks.

The gaming screen 606 may be carried by a generally vertically extending cabinet 614 of the individual electronic gaming device 600. The individual electronic gaming device 600 may further include banners (not shown) configured to communicate rules of game play and/or the like, such as along a top portion 616 of the cabinet 614 of the individual electronic gaming device 600. The individual electronic gaming device 600 may further include additional decorative lights (not shown) and speakers (not shown) for transmitting and/or receiving sounds during game play. Further detail of an example of an individual electronic gaming device 600 (as well as other embodiments of tables and devices) is disclosed in U.S. patent application Ser. No. 13/215,156, filed Aug. 22, 2011, published as U.S. Patent Application Publication No. 2013/0053117 on Feb. 28, 2013, and titled “Six-Card Poker Game,” the disclosure of which is incorporated herein in its entirety by this reference.

Some embodiments may be implemented at locations that include a plurality of player stations. Such player stations may include an electronic display screen for display of game information, such as displaying virtual cards, virtual chips, and game instructions, and for accepting wagers and facilitating credit balance adjustments. Such player stations may, optionally, be integrated in a table format, may be distributed throughout a casino or other gaming site, or may include both grouped and distributed player stations. While some features may be automated through electronic interfaces (e.g., virtual cards, virtual chips, etc.), some features may remain in the physical domain. As such, the game play may be administered by a live dealer, a virtual dealer, or a combination of both.

Referring to FIG. 7, an example of a suitable table 700 configured for implementation of embodiments of wagering games according to the present disclosure is shown. The table 700 may include a playing surface 704. The table 700 may include a plurality of player stations 712a through 712g. Each player station 712a through 712g may include a player interface 716a through 716g, which may be used for displaying game information (e.g., game instructions, input options, wager information including virtual chips, game outcomes, etc.). The player interface 716a through 716g may include a display screen in the form of a touch screen, which may be at least substantially flush with the playing surface 704 in some embodiments. Each player interface 716a through 716g may be coupled respectively with its own local game processor 714a through 714g (shown in dashed lines), although, in some embodiments, a central game processor 728 (shown in dashed lines) may be employed and may communicate directly to player interfaces 716a through 716g. In some embodiments, a combination of individual local game processors 714a through 714g and the central game processor 728 may be employed.

A communication device 760 may be included and may be operably coupled to one or more of the local game processors 714a through 714g, the central game processor 728, or combinations thereof, such that information related to operation of the table 700, information related to the game play, or combinations thereof may be communicated between the table 700 and other devices (not shown) through a suitable communication media, such as, for example, wired networks, Wi-Fi networks, and cellular communication networks.

The table 700 may further include additional features, such as a dealer chip tray 720, which may be used by the dealer to cash players in and out of the wagering game, whereas wagers and balance adjustments during game play may be performed using virtual chips. For embodiments using physical cards 706a, 706b, the table 700 may further include a card-handling device 722 that may be configured to shuffle, read, and deliver physical cards for the dealer and players to use during game play or, alternatively, a card shoe configured to read and deliver cards that have already been randomized. For embodiments using virtual cards, such virtual cards may be displayed at the individual player interfaces 716a through 716g. Common virtual cards may be displayed in a common card area (not shown).

The table 700 may further include a dealer interface 718, which, like the player interfaces 716a through 716g, may include touch screen controls for assisting the dealer in administering the wagering game. The table 700 may further include an upright display 730 configured to display images that depict game information such as pay tables, hand counts, historical win/loss information by player, and a wide variety of other information considered useful to the players. The upright display 730 may be double sided to provide such information to players as well as to a casino pit.

Further detail of an example of a table and player displays is disclosed in U.S. patent application Ser. No. 12/218,583, filed Jul. 15, 2008, published as U.S. Patent Application Publication No. 2010/0016050 on Jan. 21, 2010, now U.S. Pat. No. 8,262,475, issued Sep. 11, 2012, and now titled “Chipless Table Split Screen Feature,” the disclosure of each of which application and patent is incorporated herein in its entirety by this reference. Although an embodiment is described showing individual discrete player stations, in some embodiments, the entire playing surface 704 may be an electronic display that is logically partitioned to permit game play from a plurality of players for receiving inputs from, and displaying game information to, the players, the dealer, or both.

Referring to FIG. 8, another example of a suitable table 800 configured for implementation of embodiments of wagering games having a virtual dealer according to the present disclosure is shown. The table 800 may include player positions 814a through 814e that are arranged in a bank about an arcuate edge 820 of a video device 858 that may comprise a card screen 864 and a dealer screen 860. The dealer screen 860 may display a video simulation of the dealer (i.e., a virtual dealer) for interacting with the video device 858, such as through processing one or more programs stored in memory 895 to implement the rules of game play at the video device 858. The dealer screen 860 may be carried by a generally vertically extending cabinet 862 of the video device 858. The card screen 864 may be configured to display at least one or more of the dealer's cards, community cards, and/or player's cards dealt by the virtual dealer on the dealer screen 860 (virtual dealer not shown in FIG. 8).

Each of the player positions 814a through 814e may include a player interface area 832a through 832e that is configured for wagering and game play interactions with the video device 858 and/or virtual dealer. Accordingly, game play may be accommodated without involving physical playing cards, poker chips, and/or live personnel. The action may instead be simulated by a control processor 897 interacting with and controlling the video device 858. The control processor 897 may be located internally within, or otherwise proximate to, the video device 858. The control processor 897 may be programmed, by known techniques, to implement the rules of game play at the video device 858. As such, the control processor 897 may interact and communicate with display/input interfaces and data entry inputs for each player interface area 832a through 832e of the video device 858. Other embodiments of tables and gaming devices may include a control processor that may be similarly adapted to the specific configuration of its associated device.

A communication device 899 may be included and operably coupled to the control processor 897 such that information related to operation of the table 800, information related to the game play, or combinations thereof may be communicated between the table 800 and other devices (not shown) through a suitable communication media, such as, for example, wired networks, Wi-Fi networks, and cellular communication networks.

The video device 858 may further include banners (not shown) configured to communicate rules of play and/or the like, which may be located along one or more walls 870 of the cabinet 862. The video device 858 may further include additional decorative lights (not shown) and speakers (not shown), which may be located on an underside surface 866, for example, of a generally horizontally extending top 868 of the cabinet 862 of the video device 858 generally extending toward the player positions 814a through 814e.

Further detail of an example of a table and player displays is disclosed in U.S. patent application Ser. No. 10/764,995, filed Jan. 26, 2004, published as U.S. Patent Application Publication No. 2005/0164762 on Jul. 28, 2005, now U.S. Pat. No. 8,272,958, issued Sep. 25, 2012, and titled “Automated Multiplayer Game Table with Unique Image Feed of Dealer,” the disclosure of each of which application and patent is incorporated herein in its entirety by this reference. Although an embodiment is described showing individual discrete player stations, in some embodiments, the entire playing surface (e.g., player interface areas 832a through 832e, card screen 864, etc.) may be an electronic display that is logically partitioned to permit game play from a plurality of players for receiving inputs from, and displaying game information to, the players, the dealer, or both.

Wagering games in accordance with embodiments of the disclosure may be administered over the Internet, or otherwise online, in one embodiment using an online casino gaming system employing a client server architecture. Referring to FIG. 9, illustrated is a schematic block diagram of a gaming system 900 for implementing wagering games according to an embodiment of the present disclosure. The gaming system 900 enables end users to access proprietary and/or non-proprietary game content. Such game content may include, without limitation, various types of wagering games such as card games, dice games, big wheel games, roulette, scratch off games (“scratchers”), and any other wagering game where the game outcome is determined, in whole or in part, by one or more random events. This includes, but is not be limited to, Class II and Class III games as defined under 25 U.S.C. §2701 et seq. (“Indian Gaming Regulatory Act”). Such games may include banked and/or non-banked games.

The wagering games supported by the gaming system 900 may be operated with real currency or with virtual credits or other virtual (e.g., electronic) value indicia. For example, the real currency option may be used with traditional casino and lottery-type wagering games in which money or other items of value are wagered and may be cashed out at the end of a game session. The virtual credits option may be used with wagering games in which credits (or other symbols) may be issued to a player to be used for the wagers. A player may be credited with credits in any way allowed, including, but not limited to, a player purchasing credits; being awarded credits as part of a contest or a win event in this or another game (including non-wagering games); being awarded credits as a reward for use of a product, casino, or other enterprise, time played in one session, or games played; or may be as simple as being awarded virtual credits upon logging in at a particular time or with a particular frequency, etc. Although credits may be won or lost, the ability of the player to cash out credits may be controlled or prevented. In one example, credits acquired (e.g., purchased or awarded) for use in a play-for-fun game may be limited to non-monetary redemption items, awards, or credits usable in the future or for another game or gaming session. The same credit redemption restrictions may be applied to some or all of credits won in a wagering game as well.

An additional variation includes web-based sites having both play-for-fun and play-for-pay wagering games, including issuance of free (non-monetary) credits usable to play the play-for-fun games. This may attract players to the site and to the games before they engage in wagering. In some embodiments, a limited number of free or promotional credits may be issued to entice players to play the games. Another method of issuing credits includes issuing free credits in exchange for identifying friends who may want to play. In another embodiment, additional credits may be issued after a period of time has elapsed to encourage the player to resume playing the game. The gaming system 900 may enable players to buy additional game credits to allow the player to resume play. Objects of value may be awarded to play-for-fun players, which may or may not be in a direct exchange for credits. For example, a prize may be awarded or won for a highest scoring play-for-fun player during a defined time interval. All variations of credit redemption are contemplated, as desired by game designers and game hosts (the person or entity controlling the hosting systems).

The gaming system 900 may include a gaming platform that establishes a portal for an end user to access a wagering game hosted by a game server 906 through a user interaction server 902. The user device 920 may communicate with the user interaction server 902 of the gaming system 900 using a network 930 (e.g., the Internet). The user interaction server 902 may communicate with the game server 906 and provide game information to the user. In some embodiments, the game server 906 may also be a game engine. In some embodiments, a single user device communicates with a game provided by the game server 906, while other embodiments may include a plurality of user devices 920 configured to communicate and provide end users with access to the same game provided by the game server 906. In addition, a plurality of end users may be permitted to access a single user interaction server 902, or a plurality of user interaction servers 902, to access the game server 906.

The user interaction server 902 may communicate with the user device 920 to enable access to the gaming system 900. The user interaction server 902 may enable a user to create and access a user account and interact with the game server 906. The user interaction server 902 may enable users to initiate new games, join existing games, and interface with games being played by the user.

The user interaction server 902 may also provide a client 922 for execution on the user device 920 for accessing the gaming system 900. The client 922 provided by the gaming system 900 for execution on the user device 920 can comprise a variety of implementations according to the user device 920 and method of communication with the gaming system 900. In one embodiment, the user device 920 connects to the gaming system 900 using a web browser, and the client 922 executes within a browser window or frame of the web browser. In another embodiment, the client 922 is a stand-alone executable on the user device 920.

In one embodiment, the client 922 may comprise a relatively small amount of script (e.g., JAVASCRIPT®), also referred to as a “script driver,” including scripting language that controls an interface of the client 922. The script driver may include simple function calls requesting information from the gaming system 900. In other words, the script driver stored in the client 922 may merely include calls to functions that are externally defined by, and executed by, the gaming system 900. As a result, the client 922 may be characterized as a “thin client.” As that term is used herein, the client 922 may be little more than a script player. The client 922 may simply send requests to the gaming system 900 rather than performing logic itself. The client 922 receives player inputs, and the player inputs are passed to the gaming system 900 for processing and executing the wagering game. In one embodiment, this includes providing specific graphical display information to client 922 as well as game outcomes.

In other embodiments, the client 922 comprises an executable file rather than a script. In that case, client 922 may do more local processing than does a script driver, such as calculating where to show what game symbols upon receiving a game outcome from game server 906 through user interaction server 902. In one embodiment, it may be that portions of an asset server 904 are loaded onto the client 922 and are used by the client 922 in processing and updating graphical displays. Due to security and integrity concerns, most embodiments will have the bulk of the processing of the game play performed in the gaming system 900. However, some embodiments may include significant game processing by client 922 when the client and user device 920 are considered trustworthy or when there is reduced concern for security and integrity in the displayed game outcome. In most embodiments, it is expected that some form of data protection, such as end-to-end encryption, will be used when data is transported over the network 930. The network 930 may be any network, including, but not limited to, the Internet.

In an embodiment where the client 922 implements further logic and game control methodology beyond the thin client, the client 922 may parse and define player interactions prior to passing the player interactions to the gaming system 900. Likewise, when the client 922 receives a gaming interaction from the gaming system 900, the client 922 may be configured to determine how to modify the display as a result of the gaming interaction. The client 922 may also allow the player to change a perspective or otherwise interact with elements of the display that do not change aspects of the game.

The gaming system 900 may include an asset server 904, which may host various media assets (e.g., audio, video, and image files) that may be sent to the client 922 for presenting the various wagering games to the end user. In other words, in this embodiment, the assets presented to the end user may be stored separately from the client 922. In one embodiment, the client 922 requests the assets appropriate for the game played by the user; in other embodiments, especially those using thin clients, just those assets that are needed for a particular display event will be sent by game server 906 when the game server 906 determines they are needed, including as few as one asset. In one example, the client 922 may call a function defined at the user interaction server 902 or asset server 904, which may determine which assets are to be delivered to the client 922 as well as how the assets are to be presented by the client 922 to the end user. Different assets may correspond to the various clients that may have access to the game server 906 or to different games to be played.

The game server 906 is configured to perform game play methods and determine game play outcomes that are provided to the user interaction server 902 to be transmitted to the user device 920 for display on the end user's computer. For example, the game server 906 may include game rules for one or more wagering games, such that the game server 906 controls some or all of the game flow for a selected wagering game as well as the determined game outcomes. The game server 906 may include pay tables and other game logic. The game server 906 also performs random number generation for determining random game elements of the wagering game. In one embodiment, the game server 906 is separated from the user interaction server 902 by a firewall or other method of preventing unauthorized access to the game server 906 from the general members of the network 930.

The user device 920 may present a gaming interface to the player and communicate the user interaction to the gaming system 900. The user device 920 may be any electronic system capable of displaying gaming information, receiving user input, and communicating the user input to the gaming system 900. As such, the user device 920 can be a desktop computer, a laptop, a tablet computer, a set-top box, a mobile device (including, but not limited to, a smart phone), a kiosk, a terminal, or another computing device. The user device 920 operating the client 922 may comprise an interactive electronic gaming device 600 (see FIG. 6), as described above. The client 922 may be a specialized application or may be executed within a generalized application capable of interpreting instructions from an interactive gaming system, such as a web browser.

The client 922 may interface with an end user through a web page or an application that runs on a device, including, but not limited to, a smartphone, a tablet, or a general computer, or the client 922 may be any other computer program configurable to access the gaming system 900. The client 922 may be illustrated within a casino webpage (or other interface) indicating that the client 922 is embedded into a webpage that is supported by a web browser executing on the user device 920.

In one embodiment, the gaming system 900 may be operated by different entities. The user device 920 may be operated by a third party, such as a casino or an individual, that links to the gaming system 900, which may be operated, for example, by a wagering game service provider. Therefore, in some embodiments, the user device 920 and client 922 may be operated by a different administrator than the operator of the game server 906. In other words, the user device 920 may be part of a third-party system that does not administer or otherwise control the gaming system 900 or game server 906. In another embodiment, the user interaction server 902 and the asset server 904 are provided by a third-party system. For example, a gaming entity (e.g., a casino) may operate the user interaction server 902 or user device 920 to provide its customers access to game content managed by a different entity that may control game server 906, among other functionality. In some embodiments, these functions are operated by the same administrator. For example, a gaming entity (e.g., a casino) may elect to perform each of these functions in-house, such as providing both the access to the user device 920 and the actual game content and providing administration of the gaming system 900.

The gaming system 900 may communicate with one or more external account servers 910, optionally through another firewall. For example, the gaming system 900 itself may not directly accept wagers or issue payouts. That is, the gaming system 900 may facilitate online casino gaming but may not be part of a self-contained online casino itself. Instead, the gaming system 900 may facilitate the play of wagering games owned and controlled by a company offering games and gaming products and services, such as SHFL entertainment, Inc. Another entity (e.g., a casino or any account holder or financial system of record) may operate and maintain its external account servers 910 to accept bets and make payout distributions. The gaming system 900 may communicate with the account servers 910 to verify the existence of funds for wagering and to instruct the account server 910 to execute debits and credits.

In some embodiments, the gaming system 900 may directly accept bets and make payout distributions, such as in the case where an administrator of the gaming system 900 operates as a casino. As discussed above, the gaming system 900 may be integrated within the operations of a casino rather than having functionality (e.g., game content, game play, credits, debits, etc.) separated among different entities. In addition, for play-for-fun wagering games, the gaming system 900 may issue credits, take bets, and manage the balance of the credits according to the game outcomes, but the gaming system 900 may not permit payout distributions or be linked to the account server 910 that permits payout distributions. Such credits may be issued for free, through purchase, or for other reasons, without the ability for the player to cash out. Such play-for-fun wagering games may be administered on platforms that do not permit traditional gambling, such as to comply with rules in jurisdictions that do not permit online gambling.

The gaming system 900 may be configured in many ways, from a fully integrated single system to a distributed server architecture. The asset server 904, the user interaction server 902, the game server 906, and the account server 910 may be configured as a single, integrated system of code modules running on a single server or machine, where each of the servers is functionally implemented on a single machine. In such a case, the functionality described herein may not be implemented as separate code modules. The asset server 904, the user interaction server 902, the game server 906, and the account server 910 may also be implemented as a plurality of independent servers, each using its own code modules running on a separate physical machine, and may further include one or more firewalls between selected servers (depending on security needs). Each server could communicate over some kind of networked connection, potentially as varied as that described for the network 930. Further, each single server shown in FIG. 9 may be implemented as a plurality of servers with load balancing and scalability factors built into the embodiment. All such embodiments and variations are fully contemplated.

Additional features may be supported by the game server 906, such as hacking and cheating detection, data storage and archival, metrics generation, messages generation, output formatting for different end user devices, as well as other features and operations. For example, the gaming system 900 may include additional features and configurations as described in U.S. patent application Ser. No. 13/353,194, filed Jan. 18, 2012, published as U.S. Patent Application Publication No. 2013/0184079 on Jul. 18, 2013, and application Ser. No. 13/609,031, filed Sep. 10, 2012, published as U.S. Patent Application Publication No. 2013/0184059 on Jul. 18, 2013, both titled “Network Gaming Architecture, Gaming Systems, and Related Methods,” the disclosures of which are incorporated herein in their entirety by this reference.

The network 930 may enable communications between the user device 920 and the gaming system 900. A network (not shown) may also connect the gaming system 900 and account server 910, and, further, one or more networks (not shown) may interconnect one or more of the other servers shown collectively as the gaming system 900. In one embodiment, the network 930 uses standard communications technologies and/or protocols. Thus, the network 930 can include links using technologies such as Ethernet, 802.11, worldwide interoperability for microwave access (WIMAX®), 3G, 4G, digital subscriber line (DSL), asynchronous transfer mode (ATM), INFINIBAND®, PCI Express Advanced Switching, etc. Similarly, the networking protocols used on the network 930 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 930 can be represented using technologies and/or formats including the hypertext markup language (HTML), the extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. In another embodiment, the entities can use custom and/or dedicated data communications technologies instead of, or in addition to, the ones described above. Depending upon the embodiment, the network 930 can include links comprising one or more networks such as the Internet.

Referring to FIG. 10, a high-level block diagram of a computer system 1000 for acting as the gaming system 900 (see FIG. 9) according to one embodiment is shown. Illustrated are at least one processor 1002 coupled to a chipset 1004, as indicated in dashed lines. Also coupled to the chipset 1004 are memory 1006, a storage device 1008, a keyboard 1010, a graphics adapter 1012, a pointing device 1014, and a network adapter 1016. A display 1018 is coupled to the graphics adapter 1012. In one embodiment, the functionality of the chipset 1004 is provided by a memory controller hub 1020 and an I/O controller hub 1022. In another embodiment, the memory 1006 is coupled directly to the processor 1002 instead of to the chipset 1004.

The storage device 1008 is any non-transitory computer-readable storage medium, such as a hard drive, a compact disk read-only memory (CD-ROM), a DVD, or a solid-state memory device (e.g., a flash drive). The memory 1006 holds instructions and data used by the processor 1002. The pointing device 1014 may be a mouse, a track pad, a track ball, or another type of pointing device, and it is used in combination with the keyboard 1010 to input data into the computer system 1000. The graphics adapter 1012 displays images and other information on the display 1018. The network adapter 1016 couples the computer system 1000 to a local or wide area network.

As is known in the art, the computer system 1000 can have different and/or other components than those shown in FIG. 10. In addition, the computer system 1000 can lack certain illustrated components. In one embodiment, the computer system 1000 acting as the gaming system 900 (FIG. 9) lacks the keyboard 1010, pointing device 1014, graphics adapter 1012, and/or display 1018. Moreover, the storage device 1008 can be local and/or remote from the computer system 1000 (such as embodied within a storage area network (SAN)). Moreover, other input devices, such as, for example, touch screens may be included.

The network adapter 1016 (may also be referred to herein as a communication device) may include one or more devices for communicating using one or more of the communication media and protocols discussed above with respect to FIG. 9.

In addition, some or all of the components of this general computer system 1000 of FIG. 10 may be used as part of the processor and memory discussed above with respect to the systems of FIGS. 6, 7, and 8.

The gaming system 900 (FIG. 9) may comprise several such computer systems 1000. The gaming system 900 may include load balancers, firewalls, and various other components for assisting the gaming system 900 to provide services to a variety of user devices.

As is known in the art, the computer system 1000 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 1008, loaded into the memory 1006, and executed by the processor 1002.

Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience.

Some portions of the disclosure are presented in terms of algorithms (e.g., as represented in flowcharts, prose descriptions, or both) and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times to refer to certain arrangements of steps requiring physical manipulations or transformation of physical quantities or representations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing,” “computing,” “calculating,” “determining,” “displaying,” “determining,” or the like, refer to the action and processes of a computer system, or similar electronic computing device (such as a specific computing machine), that manipulates and transforms data represented as physical (electronic) quantities within the computer system memories or registers or other such information storage, transmission, or display devices.

Certain aspects of the embodiments include process steps and instructions described herein in the form of an algorithm. It should be noted that the process steps and instructions of the embodiments can be embodied in software, firmware, or hardware, and, when embodied in software, could be downloaded to reside on and be operated from different platforms used by a variety of operating systems. The embodiments can also be in a computer program product that can be executed on a computing system.

Some embodiments also relate to an apparatus for performing the operations herein. Such an apparatus may be specially constructed for the purposes, e.g., a specific computer, or it may comprise a general-purpose computer selectively activated or reconfigured by a computer program stored in the computer. Such a computer program may be stored in a computer-readable storage medium, such as, but is not limited to, any type of disk including floppy disks, optical disks, CD-ROMs, magnetic-optical disks, read-only memories (ROMs), random access memories (RAMS), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be a transient or non-transient medium, where a non-transient or non-transitory medium can include memory/storage that stores information for more than a minimal duration. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for the purposes of enablement and best mode.

While certain illustrative embodiments have been described in connection with the figures, those of ordinary skill in the art will recognize and appreciate that embodiments encompassed by the disclosure are not limited to those embodiments explicitly shown and described herein. Rather, many additions, deletions, and modifications to the embodiments described herein may be made without departing from the scope of embodiments encompassed by the disclosure, such as those hereinafter claimed, including legal equivalents. In addition, features from one disclosed embodiment may be combined with features of another disclosed embodiment while still being within the scope of the disclosure, as contemplated by the inventors.

1. A method of administering a wagering game, comprising:
accepting from a player an ante wager;
dealing a partial hand of cards to a player hand position to form part of a player hand;
dealing a complete hand of cards to a dealer hand position to form a complete dealer hand;
exposing the complete dealer hand to the player;
after exposing the complete dealer hand to the player, administering a game play election event comprising:
providing a set of player game play options comprising a fold election and a play wager election; and
accepting from the player an election selected from the set of player game play options;
dealing at least one community card to a community card position for use in the player hand; and
resolving all accepted wagers.

2. The method of claim 1, wherein:
accepting from the player an election selected from the set of player game play options comprises:
accepting from the player the play wager election; and
accepting from the player a play wager; and
resolving all accepted wagers comprises resolving the ante wager, comprising:
comparing a player hand rank of the player hand to a dealer hand rank of the complete dealer hand; and
paying an ante payout equal to the ante wager for the dealer hand rank at least meeting a predetermined minimum dealer qualification rank and the player hand rank exceeding the dealer hand rank.

3. The method of claim 2, wherein accepting from the player a play wager comprises accepting from the player the play wager in an amount equal to two times the ante wager.

4. The method of claim 1, wherein:
accepting from the player an election selected from the set of player game play options comprises:
accepting from the player the play wager election; and
accepting from the player a play wager; and
resolving all accepted wagers comprises resolving the ante wager, comprising retaining the ante wager for a dealer hand rank of the complete dealer hand at least meeting a predetermined minimum dealer qualification rank and the dealer hand rank exceeding a player hand rank of the player hand.

5. The method of claim 1, wherein:
accepting from the player an election selected from the set of player game play options comprises:
accepting from the player the play wager election; and
accepting from the player a play wager; and
resolving all accepted wagers comprises resolving the ante wager, comprising returning the ante wager to the player for the complete dealer hand having a dealer hand rank that does not at least meet a minimum predetermined dealer qualification rank.

6. The method of claim 1, further comprising, before dealing the partial hand of cards to the player hand position, accepting from the player a blind wager equal to the ante wager.

7. The method of claim 6, wherein:
accepting from the player an election selected from the set of player game options comprises:
accepting from the player the play wager election; and
accepting from the player a play wager; and
resolving all accepted wagers comprises resolving the blind wager, comprising paying a blind payout for the player hand having a player hand rank exceeding a dealer hand rank of the complete dealer hand and at least equaling a predetermined winning combination.

8. The method of claim 1, wherein providing a set of player game play options comprises providing the set of player game play options comprising the fold election and the play wager election for a play wager limited to an amount of two times the ante wager.

9. The method of claim 1, wherein:
accepting from the player an election selected from the set of player game play options comprises accepting from the player a play wager; and
resolving all accepted wagers comprises resolving the play wager, comprising paying a play payout for the player hand having a player hand rank exceeding a dealer hand rank of the complete dealer hand, the play payout defined by a play paytable based on the dealer hand rank.

10. The method of claim 1:
further comprising accepting from the player a bonus wager; and
resolving all accepted wager comprises resolving the bonus wager, resolving the bonus wager being independent of the election selected from the set of player game play options.

11. The method of claim 10, wherein resolving the bonus wager comprises paying a bonus payout for the player hand having a player hand rank at least equaling a predetermined minimum bonus rank of one pair, the bonus payout defined by a bonus paytable based on the player hand rank.

12. The method of claim 10, wherein resolving the bonus wager comprises paying a bonus payout for all cards of a combination of the player hand and the complete dealer hand having a combined rank at least equaling a predetermined minimum bonus rank, the bonus payout defined by a bonus paytable based on the combined rank.

13. The method of claim 10:
further comprising accepting from the player a progressive side wager; and
wherein accepting from the player an election selected from the set of player game play options comprises accepting from the player a play wager; and
wherein resolving all accepted wagers comprises resolving the progressive side wager, comprising paying a progressive payout for the player hand having a player hand rank equaling a predetermined progressive rank, the progressive payout based on a percentage of a progressive pot.

14. The method of claim 10:
further comprising accepting from the player a progressive side wager; and
wherein accepting from the player an election selected from the set of player game play options comprises accepting from the player a play wager; and
wherein resolving all accepted wagers comprises resolving the progressive side wager, comprising paying a side paytable payout for the player hand having a player hand rank not equaling a predetermined progressive rank but at least equaling a predetermined progressive paytable rank, the side paytable payout defined by a side paytable based on the player hand rank.

15. The method of claim 10:
further comprising:
accepting from another player an ante wager;
accepting from the player a progressive side wager;
accepting from the another player another progressive side wager; and
dealing another player hand to another player hand position; and
wherein:
accepting from the player an election selected from the set of player game play options comprises accepting from the player a play wager; and
resolving all accepted wagers comprises resolving the progressive side wager, comprising paying an envy payout to the player for the another player hand having a hand rank equaling a predetermined progressive rank.

16. The method of claim 1, wherein dealing a complete hand of cards to a dealer hand position to form a complete dealer hand comprises dealing three cards to the dealer hand position to form a three-card complete dealer hand.

17. The method of claim 1, wherein dealing a partial hand of cards to a player hand position to form part of a player hand comprises dealing two cards to the player hand position to form part of the player hand.

18. The method of claim 1, wherein dealing at least one community card comprises dealing one community card.

19. A method of administering a wagering game, comprising:
providing a playing device layout bearing at least three distinct wager areas comprising an ante wager area, a blind wager area, and a play wager area, the at least three distinct wager areas defined by separate insignia displayed on the playing device layout;
accepting from a player an ante wager at least partially covering the ante wager area, the ante wager designated to be resolved based on a rank comparison of a player hand rank and a dealer hand rank and another rank comparison of the dealer hand rank and a predetermined minimum qualifying rank;
accepting from the player a blind wager at least partially covering the blind wager area, the blind wager equaling the ante wager, the blind wager designated to be resolved based on the rank comparison of the player hand rank and the dealer hand rank, wherein a winning blind condition is a prerequisite for paying a blind payout defined by a blind paytable based on the player hand rank outranking the dealer hand rank;
dealing two cards for a player hand;
dealing three cards for a dealer hand, the dealer hand consisting of the three cards;
exposing the dealer hand to the player;
after exposing the dealer hand to the player and without yet completing the player hand, administering a game play election event comprising:
providing a set of player game play options consisting of
a fold election and
a play wager equaling two times the ante wager and designated to be resolved based on the rank comparison of the player hand rank and the dealer hand rank, wherein a winning play condition is a prerequisite for paying a play payout defined by a play paytable based on the dealer hand rank; and
accepting from the player a game play election selected from the set of player game play options; and
resolving all accepted wagers.

20. The method of claim 19:
wherein accepting from the player a game play election comprises accepting from the player the play wager at least partially covering the play wager area; and
further comprising, after accepting from the player the play wager, dealing at least one community card to complete the player hand.

21. A gaming table for administering a wagering game, comprising:
a playing surface including at least one player interface;
at least one dealer interface; and
at least one processor programmed to:
accept an ante wager instruction associated with an ante wager on the wagering game;
display a partial player hand;
display a complete dealer hand;
prior to completing a player hand, accept a game play election instruction selected from a fold election and a play wager instruction;
display at least one community card to form a complete player hand; and
resolve all accepted wagers instructions.

22. A system for administering a wagering game over a computer network, comprising:
an online gaming server;
a player interface and associated display for accessing the online gaming server; and
a network enabling communication between the online gaming server and the player interface;
wherein the online gaming server is programmed to administer a game to a player interacting with the game through the player interface according to the following steps:
receiving a signal from the player interface indicating the receipt of an ante wager and a blind wager from the player;
delivering a visual representation of a complete hand of dealer cards and displaying the complete hand of dealer cards on a player display associated with the player interface;
delivering a partial hand of player cards and displaying the partial hand of player cards on the player display associated with the player interface;
administering a game play election event comprising providing a set of player game play options comprising a fold election and a play wager election;
receiving a signal in response to a player input made at the player interface indicating an election selected from the set of player game play options;
delivering at least one additional card and displaying a visual representation of the at least one additional card on the player display, and adding the at least one additional card to the partial hand of player cards to form the player hand; and
resolving all received wagers.

23. The system of claim 22, wherein the player interface is selected from the group consisting of a personal computer, a mobile device, a tablet, and a mobile phone.

24. The system of claim 22, wherein the online gaming server comprises a client interaction server and a separate game results server.
